(19) United States
(12) Patent Application Publication
(10) Pub. No.: US 2017/0046376 A1
(43) Pub. Date: Feb. 16, 2017

(54) METHOD AND SYSTEM FOR MONITORING DATA QUALITY AND DEPENDENCY

(71) Applicant: Yahoo! Inc., Sunnyvale, CA (US)

(72) Inventors: Guangxin Yang, Beijing (CN); Ji Zhou, Beijing (CN); Shuo Yang, Beijing (CN); Yan Xia, Beijing (CN); Xiaojuan Wei, Beijing (CN)

(21) Appl. No.: 14/436,939

(22) PCT Filed: Apr. 3, 2015
(86) PCT No.: PCT/CN2015/075876

§ 371 Date: Apr. 20, 2015

(51) Int. Cl. G06F 17/30

(52) U.S. Cl. CPC G06F 17/30371; G06F 17/30303; G06F 17/30604

(57) ABSTRACT

The present teaching relates to monitoring data in a plurality of data sources of heterogeneous types. In one example, a request is received for monitoring data in the data sources of heterogeneous types. One or more metrics are determined based on the request. The request is converted into one or more queries based on the one or more metrics. Each of the one or more queries is directed to at least one of the data sources of heterogeneous types. A monitoring task is created for monitoring the data in the data sources based on the one or more queries in response to the request.

### BACKGROUND

1. Technical Field

The present teaching relates to methods, systems, and programming for data processing. Particularly, the present teaching is directed to methods, systems, and programming for monitoring data quality and dependency.

2. Discussion of Technical Background

The advancement in the Internet has made it possible to make a tremendous amount of information accessible to users located anywhere in the world. This introduces new challenges in data processing for “big data,” where a data set can be so large or complex that traditional data processing applications are inadequate. For big data processing, users can easily lose track of the quality of the data for their interested applications.

Conventional approaches for monitoring data quality in a database require a user to input a query directed to the database. When the user wants to monitor data in a plurality of data sources in a big data system, the user has to input a plurality of queries each of which corresponds to a data source, which is time-consuming for the user. The user also has to learn different query languages for different types of data sources. In addition, there is no easy way for the user to obtain interrelationship among different jobs running on a same cluster or on different clusters in the big data system.

Therefore, there is a need to develop techniques to monitor data quality to overcome the above drawbacks.

### SUMMARY

The present teaching relates to methods, systems, and programming for data processing. Particularly, the present teaching is directed to methods, systems, and programming for monitoring data quality and dependency.

In one example, a method, implemented on a machine having at least one processor, storage, and a communication platform connected to a network for monitoring data in a plurality of data sources of heterogeneous types is disclosed. A request is received for monitoring data in the data sources of heterogeneous types. One or more metrics are determined based on the request. The request is converted into one or more queries based on the one or more metrics. Each of the one or more queries is directed to at least one of the data sources of heterogeneous types. A monitoring task is created for monitoring the data in the data sources based on the one or more queries in response to the request.

In another example, a system, having at least one processor, storage, and a communication platform connected to a network for monitoring data in a plurality of data sources of heterogeneous types is disclosed. The system comprises a user request receiver, a metrics determiner, a query generator, and a monitoring task generator. The user request receiver is configured for receiving a request for monitoring data in the data sources of heterogeneous types. The metrics determiner is configured for determining one or more metrics based on the request. The query generator is configured for converting the request into one or more queries based on the one or more metrics. Each of the one or more queries is directed to at least one of the data sources of heterogeneous types. The monitoring task generator is configured for creating a monitoring task for monitoring the data in the data sources based on the one or more queries in response to the request.

Other concepts relate to software for implementing the present teaching on monitoring data in a plurality of data sources of heterogeneous types. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a machine-readable, non-transitory and tangible medium having information recorded thereon for monitoring data in a plurality of data sources of heterogeneous types is disclosed. The information, when read by the machine, causes the machine to perform the following. A request is received for monitoring data in the data sources of heterogeneous types. One or more metrics are determined based on the request. The request is converted into one or more queries based on the one or more metrics. Each of the one or more queries is directed to at least one of the data sources of heterogeneous types. A monitoring task is created for monitoring the data in the data sources based on the one or more queries in response to the request.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level depiction of an exemplary networked environment for monitoring data in a plurality of data sources, according to an embodiment of the present teaching;

FIG. 2 is a high level depiction of another exemplary networked environment for monitoring data in a plurality of data sources, according to an embodiment of the present teaching;

FIG. 3 illustrates an exemplary diagram of a data source monitoring engine, according to an embodiment of the present teaching;

FIG. 4 is a flowchart of an exemplary process performed by a data source monitoring engine, according to an embodiment of the present teaching;

FIG. 5 illustrates an exemplary diagram of a monitoring task managing unit, according to an embodiment of the present teaching;

FIG. 6 is a flowchart of an exemplary process performed by a monitoring task managing unit, according to an embodiment of the present teaching;

FIG. 7 illustrates an exemplary diagram of a monitoring task scheduler, according to an embodiment of the present teaching;

FIG. 8 is a flowchart of an exemplary process performed by a monitoring task scheduler, according to an embodiment of the present teaching;

FIG. 9 illustrates an exemplary diagram of a task result reporter, according to an embodiment of the present teaching;

FIG. 10 is a flowchart of an exemplary process performed by a task result reporter, according to an embodiment of the present teaching;

FIG. 11 illustrates an exemplary diagram of a data dependency analyzing engine, according to an embodiment of the present teaching;

FIG. 12 is a flowchart of an exemplary process performed by a data dependency analyzing engine, according to an embodiment of the present teaching;

FIG. 13 illustrates a user interface displayed to a user for the user to select an existing monitoring task or a shared monitoring task, according to an embodiment of the present teaching;

FIG. 14 illustrates another user interface displayed to a user regarding a monitoring task, according to an embodiment of the present teaching;

FIG. 15 illustrates a user interface displayed to a user to show results associated with a monitoring task, according to an embodiment of the present teaching;

FIG. 16 illustrates a user interface displayed to a user to show alerts generated for a monitoring task, according to an embodiment of the present teaching;

FIG. 17 illustrates a user interface displayed to a user to show a data dependency graph in a cluster, according to an embodiment of the present teaching;

FIG. 18 illustrates another user interface displayed to a user to show a data dependency graph in a cluster, according to an embodiment of the present teaching;

FIG. 19 depicts the architecture of a mobile device which can be used to implement a specialized system incorporating the present teaching; and

FIG. 20 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of monitoring data, realized as a specialized and networked system by utilizing one or more computing devices (e.g., mobile phone, personal computer, etc.) and network communications (wired or wireless). The method and system as disclosed herein aim at monitoring data in an effective and efficient manner.

Data quality has different meanings for different people. For some people, data quality means how the values for a particular feature are statistically distributed. For other people, data quality means how the distribution changes over time. For other people, data quality means how features from different data sources are co-related, e.g. matching, overlapping, etc. The system disclosed in the present teaching may automatically access and monitor data quality from different data sources, based on a user's request which can indicate what data quality means for the user and what data to monitor. The system may determine some metrics based on the request, and convert the request into some queries based on the metrics. For heterogeneous types of data sources, the user does not have to know any query language regarding the data sources. The system can generate and optimize the queries automatically.

For example, when a user wants to monitor data from Hive, HDFS (Hadoop Distributed File System), and PIG, the user can just send a request to specify some metrics, without knowing query languages of Java and Hive QL. The system in the present teaching may convert the request to some queries, each of which is directed to at least one of Hive, HDFS, and PIG. The system can optimize the queries to make them efficient and effective, e.g. based on the data structure in each of the data sources.

Usually, the request may be related to monitoring data periodically. Accordingly, the system can create a monitoring task based on the optimized queries. The system can then store the monitoring task and run it periodically. The user can input the request by e.g. selecting one or more jobs in some clusters of a data system that includes different data sources. The terms “job,” “table,” and “task” here may be used interchangeably to mean a Hive table, an Oozie job, or a HDFS feed. The request may indicate some alert conditions for generating alerts or warnings related to the monitoring. The system may generate an alert and send it to the user, if one of the alert conditions is met after the monitoring task is executed.

In one example, the user can select one of existing monitoring tasks provided by the system to generate a monitoring request. In another example, the user can share monitoring tasks with other users. For example, a user can select one of monitoring tasks shared by other users to generate a monitoring request. A user can determine whether a monitoring task of his/hers is shared or not. A user can also determine a group of users to share his/her monitoring task(s). The system can provide a user interface for the user to input the request, determine metrics, determine alert conditions, determine sharing scope, etc.

Thus, the user does not need to know any query languages or write any queries to monitor data. Once the user sends a request, the system can perform the monitoring task periodically, based on automatically generated queries. The user does not need to worry about the monitoring if not receiving any alert from the system.

In addition, the system can generate a data dependency graph that can reflect and track overall status and healthiness of data processing jobs, e.g. big data pipelines. In one example, the data dependency graph includes a first set of nodes each of which representing a data source, a second set of nodes each of which representing a data processing job, e.g. a running pipeline step, and a set of arrows each of which connecting two nodes and representing a dependency relationship between the two nodes. For example, if an arrow starts from a node representing a data source and ends at a node representing a running pipeline step, the system has determined that the running pipeline step depends on the data source, e.g. consumes data from the data source. In this manner, the data dependency graph generated by the system can provide a visual illustration of data relationships among the data sources and running pipeline steps. Based on the data dependency graph, the user can easily understand a potential impact if the user wants to modify any data, add a running pipeline step, or delete a running pipeline step. As such, the data dependency graph can enable more efficient data monitoring, troubleshooting, resource allocation, and system operations on a big data system.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

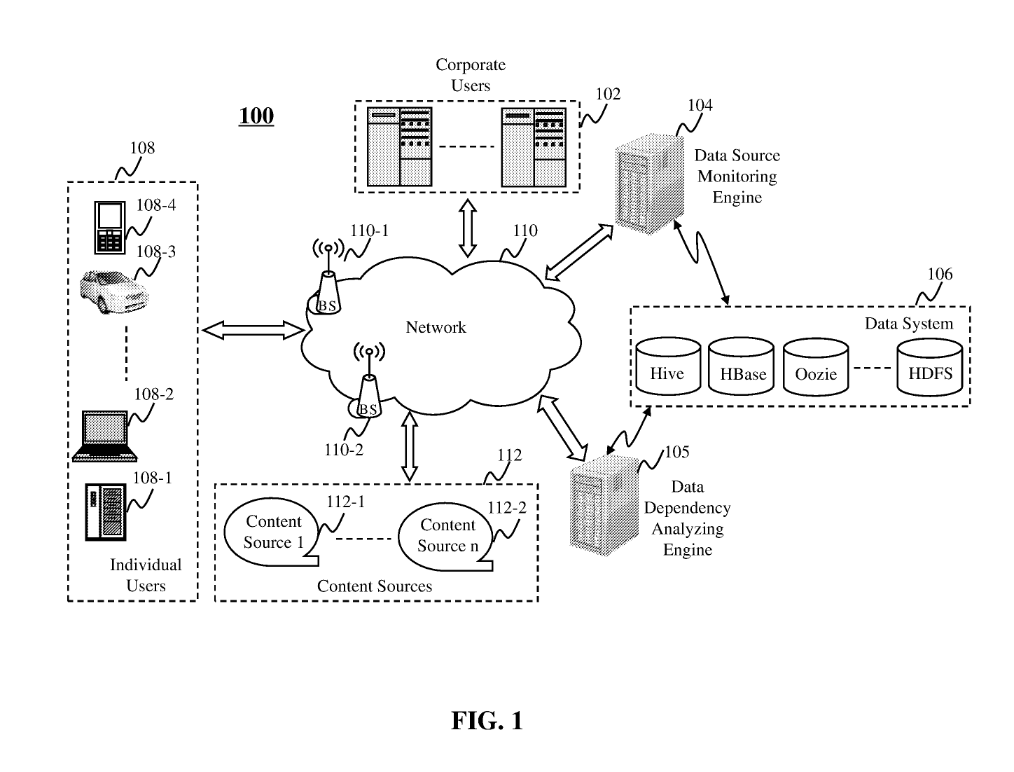

FIG. 1 is a high level depiction of an exemplary networked environment for monitoring data in a plurality of data sources, according to an embodiment of the present teaching. In FIG. 1, the exemplary networked environment 100 includes corporate users 102, individual users 108, a data source monitoring engine 104, a data dependency analyzing engine 105, a data system 106, a network 110, and content sources 112. The network 110 may be a single network or a combination of different networks. For example, the network 110 may be a local area network (LAN), a wide area network (WAN), a public network, a private network, a proprietary network, a Public Telephone Switched Network (PSTN), the Internet, a wireless network, a virtual network, or any combination thereof. In an example of Internet advertising, the network 110 may be an online advertising network or ad network that is a company connecting advertisers to web sites that want to host advertisements. The network 110 may also include various network access points, e.g., wired or wireless access points such as base stations or Internet exchange points 110-1 . . . 110-2, through which a data source may connect to the network 110 in order to transmit information via the network 110.

Individual users 108 may be of different types such as users connected to the network 110 via desktop computers 108-1, laptop computers 108-2, a built-in device in a motor vehicle 108-3, or a mobile device 108-4. An individual user 108 may send a request to the data source monitoring engine 104 via the network 110 for monitoring data in the data system 106. Based on the request, the data source monitoring engine 104 may generate a monitoring task and execute it periodically to monitor data in the data system 106. The data source monitoring engine 104 may generate and send an alert to the user if a pre-determined alert condition is met after the monitoring task is executed.

More often than not, a corporate user 102 can send a request to the data source monitoring engine 104 via the network 110 for monitoring data in the data system 106. The corporate user 102 may represent a company, a corporation, a group of users, an entity, etc. For example, a company that is an Internet service provider may want to monitor data related to online activities of users of the Internet service provided by the company. In that case, the data may be stored in the data system 106 as various types, e.g. in databases like Hive, HBase, Oozie, HDFS, etc. This may be because users' online activities can include different types of actions and hence be related to different and heterogeneous types of data.

The data source monitoring engine 104 may receive a request for monitoring data in the data system 106, from either a corporate user 102 or an individual user 108. The data source monitoring engine 104 can determine metrics based on the request and convert the request into one or more queries based on the metric. The data source monitoring engine 104 can also optimize the queries that may be directed to data sources of heterogeneous types. The data source monitoring engine 104 may generate a monitoring task based on the optimized queries and execute it periodically to monitor data in the data system 106. Based on the request, the data source monitoring engine 104 can also generate one or more alert conditions associated with the monitoring task, such that the data source monitoring engine 104 can generate and send an alert to the user if one of the alert conditions is met after the monitoring task is executed.

The data dependency analyzing engine 105 may collect information from different data sources in the data system 106 and information from different data processing jobs, e.g. running pipeline steps. The data dependency analyzing engine 105 may determine dependency relationships among the data sources and running jobs to generate a data dependency graph. The data dependency graph may include nodes representing data sources, nodes representing running jobs, and arrows each of which connecting two nodes and representing a dependency relationship between the two nodes. The data dependency graph may be generated either periodically or upon request. The data dependency analyzing engine 105 can provide the data dependency graph to a user for the user's better understanding of the data in the data system 106.

The content sources 112 include multiple content sources 112-1, 112-2 . . . 112-3, such as vertical content sources. A content source 112 may correspond to a website hosted by an entity, whether an individual, a business, or an organization such as USPTO.gov, a content provider such as cnn.com and Yahoo.com, a social network website such as Facebook.com, or a content feed source such as tweeter or blogs. A corporate user 102, e.g. a company that maintains a web site and/or runs a search engine may access information from any of the content sources 112-1, 112-2 . . . 112-3.

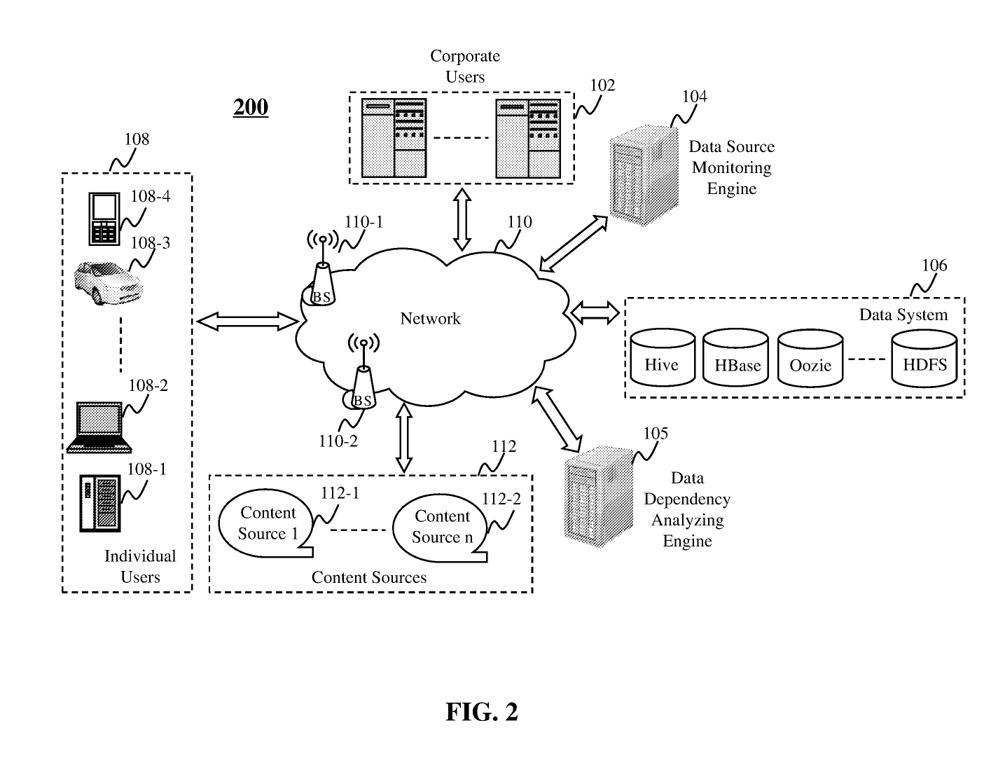

FIG. 2 is a high level depiction of another exemplary networked environment 200 for monitoring data in a plurality of data sources, according to an embodiment of the present teaching. The exemplary networked environment 200 in this embodiment is similar to the exemplary networked environment 100 in FIG. 1, except that the data system 106 connects to the network 110 directly.

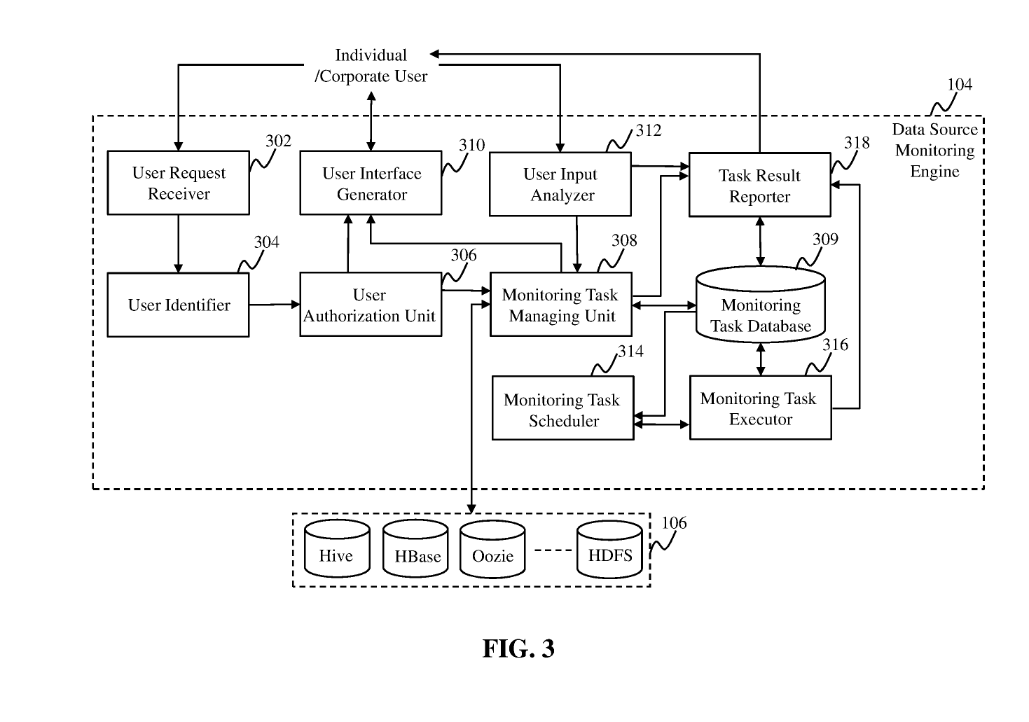

FIG. 3 illustrates an exemplary diagram of a data source monitoring engine 104, according to an embodiment of the present teaching. The data source monitoring engine 104 in this example includes a user request receiver 302, a user identifier 304, a user authorization unit 306, a monitoring task managing unit 308, a monitoring task database 309, a user interface generator 310, a user input analyzer 312, a monitoring task scheduler 314, a monitoring task executor 316, and a task result reporter 318.

The user request receiver 302 in this example obtains a request for managing a monitoring task. The request may come from an individual user 108 or a corporate user 102. The user request receiver 302 may keep receiving requests and send them to the user identifier 304 for user identification.

The user identifier 304 in this example identifies the user based on the request. The user identifier 304 can send an identity of the user to the user authorization unit 306 for user authorization. The user authorization unit 306 in this example determines authorization information for the user and determines whether the user should be authorized for monitoring data. For example, a lower level corporate user of a company may only monitor a limited set of data related to the company, while a higher level corporate user may monitor all data related to the company. If the user authorization unit 306 determines that the user is not authorized to monitor data indicated in the request, the user authorization unit 306 can send an instruction to the user interface generator 310 to deny the user's request. If the user authorization unit 306 determines that the user is authorized to monitor data indicated in the request, the user authorization unit 306 can send another instruction to the monitoring task managing unit 308 to process the user's request for data monitoring.

The monitoring task managing unit 308 in this example receives the authorization information and the request from the user authorization unit 306 and identifies data sources based on the authorization information and the request, from the data system 106. The monitoring task managing unit 308 determines existing tasks and tables in the data sources associated with the user, from the monitoring task database 309 where existing monitoring tasks are stored. The monitoring task managing unit 308 can then retrieve the tasks and tables and provide them to the user via a user interface generated by the user interface generator 310.

The user interface generator 310 in this example may receive an instruction from the user authorization unit 306 to deny the user's request. In that case, the user is not authorized to monitor data indicated in the request. Thus, the user interface generator 310 may generate a user interface to indicate that the request is denied. The user interface may include reasons that the request is denied, e.g. “data monitoring regarding such data is not open to users at your level.” The user interface may also include an option for the user to input another request, with an instruction like “Please enter another request by selecting from the following tables.”

The user interface generator 310 in this example may also receive a message from the monitoring task managing unit 308 to provide the tasks and tables to the user. In that case, the user is authorized to monitor data indicated in the request. Thus, the user interface generator 310 may generate a user interface to provide the tasks and tables from data sources associated with the user. Through the user interface, the user may input selections for monitoring data of his/her interest. The selections may be based on existing monitoring tasks, shared monitoring tasks, and/or tables or columns associated with the user.

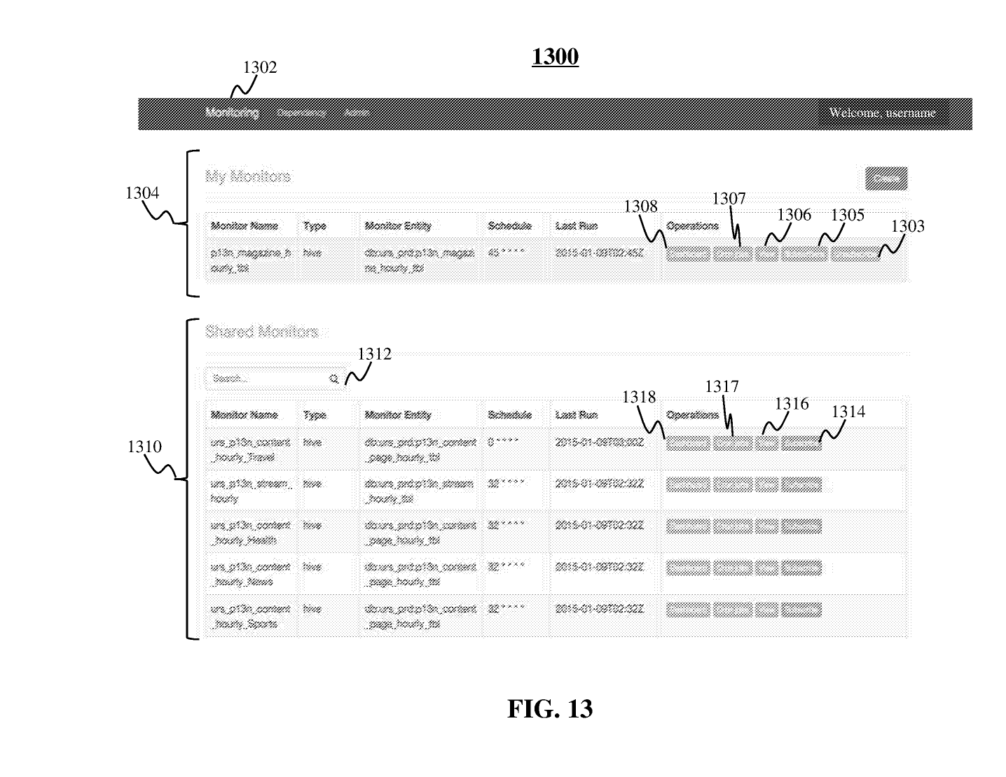

FIG. 13 illustrates a user interface 1300 displayed to a user for the user to select an existing monitoring task or a shared monitoring task, according to an embodiment of the present teaching. As illustrated in FIG. 13, the user interface 1300 in this example includes a menu bar 1302 which indicates that the user is under monitoring mode. The user interface 1300 also includes a “My Monitors” section 1304 which includes the user's existing monitoring tasks. The user interface 1300 also includes a “Shared Monitors” section 1310 which includes the monitoring tasks shared with the user by other users.

As illustrated in FIG. 13, each of the existing monitoring tasks may include information about monitor name, type, monitor entity, schedule, last run time, and operation options related to the monitoring task. It can be understood by one skilled in the art that although the user interface 1300 includes monitoring tasks of Hive type, other types of monitoring tasks can be included in the existing monitoring tasks and/or shared monitoring tasks as well, e.g. types of HDFS, Oozie, HBase, etc. The operation options for each existing monitoring task may include a “Dashboard” button 1308, a “Cron jobs” button 1307, a “view” button 1306, a “Subscribers” button 1305, and an “unsubscribe” button 1303. By clicking on the “view” button 1306, the user can access detailed information related to the monitoring task. By clicking on the “Dashboard” button 1308, the user can access previous execution results associated with the monitoring task. The user can check a list of other users who have subscribed to the monitoring task, by clicking on the “Subscribers” button 1305. The user can also unsubscribe from the monitoring task, by clicking on the “unsubscribe” button 1303.

Like existing monitoring tasks, each of the shared monitoring tasks may include information about monitor name, type, monitor entity, schedule, last run time, and operation options related to the monitoring task. The operation options for each shared monitoring task may include a “Dashboard” button 1318, a “Cron jobs” button 1317, a “view” button 1316, and a “Subscribe” button 1314. By clicking on the “view” button 1316, the user can access detailed information related to the shared monitoring task. By clicking on the “Dashboard” button 1318, the user can access previous execution results associated with the shared monitoring task. The user can also subscribe to the shared monitoring task, by clicking on the “Subscribe” button 1314.

Each of the shared monitoring tasks is associated with a username. The “Shared Monitors” section 1310 can include a search box 1312 for the user to search shared monitoring tasks, e.g. by username, by monitor name, or by type. Through the user interface 1300, the user can select one or more tasks from the existing monitoring tasks and/or shared monitoring tasks to monitor data in the data system 106.

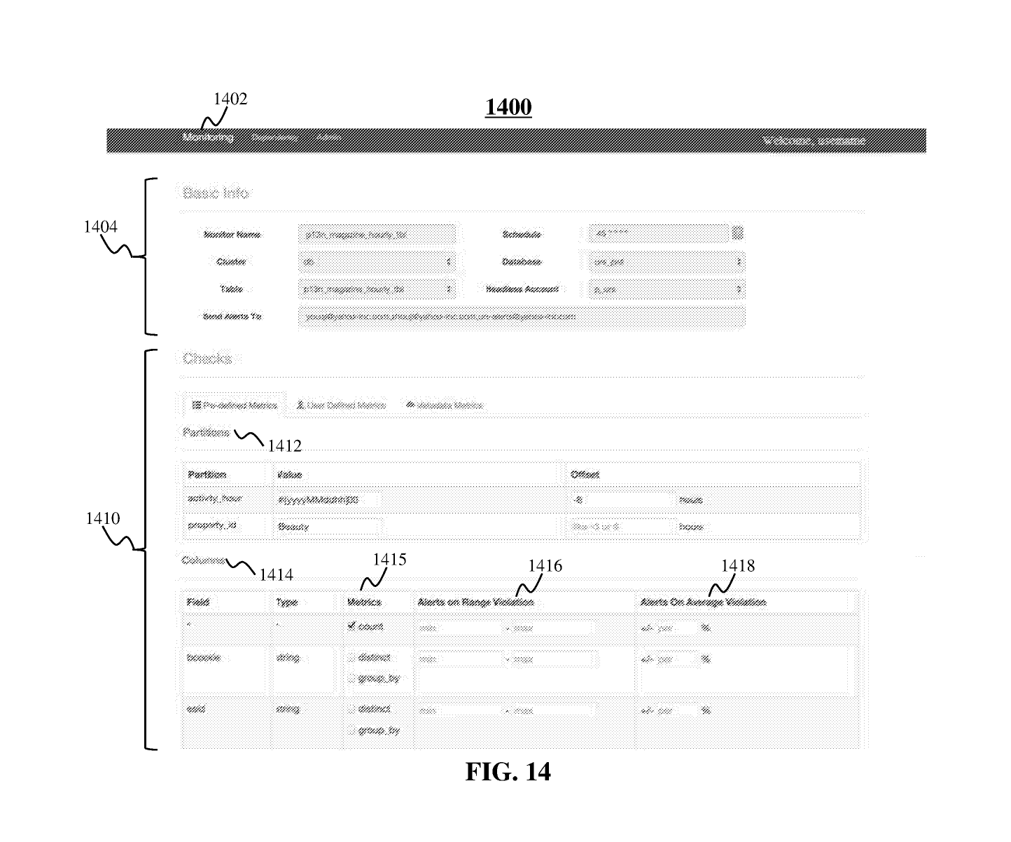

FIG. 14 illustrates another user interface 1400 displayed to a user regarding a monitoring task, according to an embodiment of the present teaching. The user interface 1400 in this example includes information about a monitoring task named “p13n_magazine_hourly_tbl.” The user interface 1400 may be displayed to a user after the user clicked on the “view” button 1306 in the user interface 1300 as shown in FIG. 13.

As illustrated in FIG. 14, the user interface 1400 in this example includes a menu bar 1402 which indicates that the user is under monitoring mode. The user interface 1400 also includes a “Basic Info” section 1404 which includes basic information about the monitoring task named “p13n_magazine_hourly_tbl.” The basic information may include monitor name, schedule of the task, cluster related to the task, database related to the task, table related to the task, headless account related to authority information, and email addresses for receiving alerts.

The user interface 1400 may also include a “Checks” section 1410 which includes information about pre-defined metrics for the monitoring task. The user can modify the pre-defined metrics shown in the “Checks” section 1410, such that the monitoring task “p13n_magazine_hourly_tbl” may be associated with modified metrics.

The table specified in FIG. 14 may include some partitions 1412, each of which may be a special column that can be used to provide a condition for monitoring the data in the table. For example, one of the partitions 1412 is activity_hour with an offset of −8 hours, and another partition in the partitions 1412 is property_id with a value of Beauty. This means when the monitoring task is executed at time T, the system will perform actions according to the metrics under the columns 1414, directed to records that are associated with Beauty and included in the table 8 hours before time T. The user may change the value of the property_id, and/or change the offset of the activity_hour for this monitoring task.

The user may also change the selections with respect to the columns 1414 that are included in the table. For example, metric “count” is currently selected in FIG. 14 for this task, and therefore the system will monitor and generate the number of records having the activity_hour and property specified above and being included in the table. The user may also select other columns for monitoring, e.g. by clicking on the box besides “distinct” and/or “group_by” under metrics 1415. In one example, if “distinct” is selected for the field of “bcookie,” the system will monitor and generate the number of distinct “bcookie” records included in the table, with conditions regarding activity_hour and property specified above. In another example, if “group_by” is selected for the field of “esid,” the system will group the records according to their respective “esid” values such that records having the same “esid” value are assigned into a same group, and count the number of “esid” groups in the table, with conditions regarding activity_hour and property specified above. It can be understood by one skilled in the art that other columns and/or partitions may be included in the user interface 1400.

The user can also specify alert conditions under the columns section 1414. In one case, the user can input min and max values under “Alerts on Range Violation” 1416, regarding some field and metric. For example, the user may specify the min value for a field of “age” to be 0 and the max value for the field of “age” to be 200. Then, if the system finds a record with an “age” value outside the range of 0˜200 after executing the monitoring task, the system will generate an alert and send it to the email addresses specified in the “Basic Info” section 1404.

In another case, the user can input a percentage number under “Alerts on Average Violation” 1418, regarding some field and metric. For example, a corporate user that is an Internet web site provider may input 20% under “Alerts on Average Violation” 1418 for a field of “views”. This may be because the corporate user expects the number of views of its web site in a time period to be different from the average number of views by no more than 20%. There can be different ways to define the average number of views. In one example, if the time period mentioned above is an hour, the average number of views can be calculated by averaging the numbers of views in a plurality of hours before the time period. In another example, if the time period mentioned above is an hour, the average number of views can be calculated by averaging the numbers of views at the same time in days before the time period. For example, if the time period mentioned above is during 5:00 PM to 6:00 PM today, the average number of views may be calculated by averaging the numbers of views during 5:00 PM to 6:00 PM yesterday, during 5:00 PM to 6:00 PM the day before yesterday, and during 5:00 PM to 6:00 PM three days before today. Then, if the number of views based on an execution of the monitoring task is different from the average number of views by more than 20%, the system will generate an alert and send it to the email addresses specified in the “Basic Info” section 1404.

An alert may be a warning about an error, e.g. when a person's age is recorded to be a value below 0. An alert may also be an unexpected good fact, e.g. when a web site's views increase more than expected compared to an average number of views. Based on the set alert conditions, the system can send an alert to a user, either for the user to notice and correct an error or for the user to notice and analyze an unexpected good fact or result.

Referring back to FIG. 3, the user interface generator 310 may generate and send the user interface 1300 to the user, for the user to select from existing and/or shared monitoring tasks. The user interface generator 310 may also generate and send the user interface 1400 to the user, for the user to select and/or modify information associated with a monitoring task, e.g. tables, columns, are metrics, such that the user can build up a monitoring task based on his/her selections.

The user input analyzer 312 in this example can receive and analyze user inputs via the user interface provided to the user by the user interface generator 310. The input may include the user's selection of metrics, input about alert condition parameters, request for monitoring task result, and/or other information related to data monitoring. The user input analyzer 312 may analyze and sort out the inputs, and send analyzed inputs to the monitoring task managing unit 308 for managing monitoring task and to the task result reporter 318 for task result reporting.

The monitoring task managing unit 308 in this example may receive the analyzed inputs from the user input analyzer 312, and generate and/or update a monitoring task associated with the user based on the analyzed inputs, e.g. the user specified metrics and alert conditions for data monitoring. The monitoring task managing unit 308 may store the monitoring task associated with some metadata and the user's personal information into the monitoring task database 309 where information about different monitoring tasks associated with different users can be stored. The metadata may include information associated with the monitoring task, e.g. information about alert conditions, partition conditions, schedule of the monitoring task, etc. The user's personal information may include the user's user ID, the user's authority level, other users associated with the user, etc. In one embodiment, the monitoring task managing unit 308 may send alert conditions associated with a monitoring task to the task result reporter 318 for generating an alert when one of the alert conditions is met.

The monitoring task scheduler 314 in this example can schedule different monitoring tasks stored in the monitoring task database 309 for execution. In one embodiment, the monitoring task scheduler 314 may determine all monitoring tasks to be executed in next time period, e.g. next hour, based on the schedule information of the monitoring tasks stored in the monitoring task database 309. The monitoring task scheduler 314 may retrieve the monitoring tasks to be executed in the next time period from the monitoring task database 309 and store them in a task queue, in a sequence according to their respective running schedules. According to a timer, the monitoring task scheduler 314 can extract the next monitoring task in the task queue when the scheduled time comes, and send it to the monitoring task executor 316 for execution.

The monitoring task executor 316 in this example executes monitoring tasks received from the monitoring task scheduler 314. In one embodiment, the monitoring task executor 316 sends a task request to the monitoring task scheduler 314, when the monitoring task executor 316 has an idle processor for performing a monitoring task. The monitoring task scheduler 314 may send the monitoring task executor 316 the next monitoring task in the task queue, either upon the request or waiting for the schedule running time for the next monitoring task. After the monitoring task executor 316 receives the monitoring task, it will execute the task based on the metrics associated with the task, and generate a task result accordingly. In one embodiment, the monitoring task executor 316 may store the task result into the monitoring task database 309 associated with the monitoring task. In another embodiment, the monitoring task executor 316 may send the task result to the task result reporter 318 for generating a task result report. In yet another embodiment, the monitoring task scheduler 314 may merely send information (e.g. a task ID) about the next monitoring task to the monitoring task executor 316, and the monitoring task executor 316 can retrieve the next monitoring task based on the information from the monitoring task database 309 for execution.

The task result reporter 318 in this example analyzes one or more alert conditions associated with an executed monitoring task and determines whether any of the alert conditions is met based on the executed task result. The task result reporter 318 may receive the result of the executed monitoring task from the monitoring task executor 316. The task result reporter 318 may obtain the alert conditions associated with the executed monitoring task either from the monitoring task managing unit 308 or from the monitoring task database 309. If the task result reporter 318 determines one of alert conditions is met, the task result reporter 318 may generate an alert accordingly. The task result reporter 318 may generate multiple alerts each of which is triggered by a different alert condition associated with the executed monitoring task. The task result reporter 318 may then store the generated alert(s) associated with the executed monitoring task in the monitoring task database 309, and/or send the generated alert(s) to the user, e.g. by sending an email to the email addresses listed in the “Basic Info” section 1404 in FIG. 14.

The task result reporter 318 in this example may also generate a result report or summary associated with a monitoring task, either periodically or upon request from a user. In one embodiment, the user input analyzer 312 receives a user request, via a user interface, for a result report regarding a monitoring task, and forwards the request to the task result reporter 318. The task result reporter 318 then retrieves results from previous executions of the monitoring task from the monitoring task database 309, based on the request. For example, the task result reporter 318 may retrieve results of the monitoring task executed during the last three months or during the last year. The task result reporter 318 can then generate a result summary based on the retrieved results and send it to the user in response to the user request.

In another embodiment, the task result reporter 318 may retrieve results for a monitoring task and generate a result summary for the task periodically or according to a timer. For example, the task result reporter 318 may generate a result summary for a monitoring task every week or every month, and send it to one or more users associated with the monitoring task.

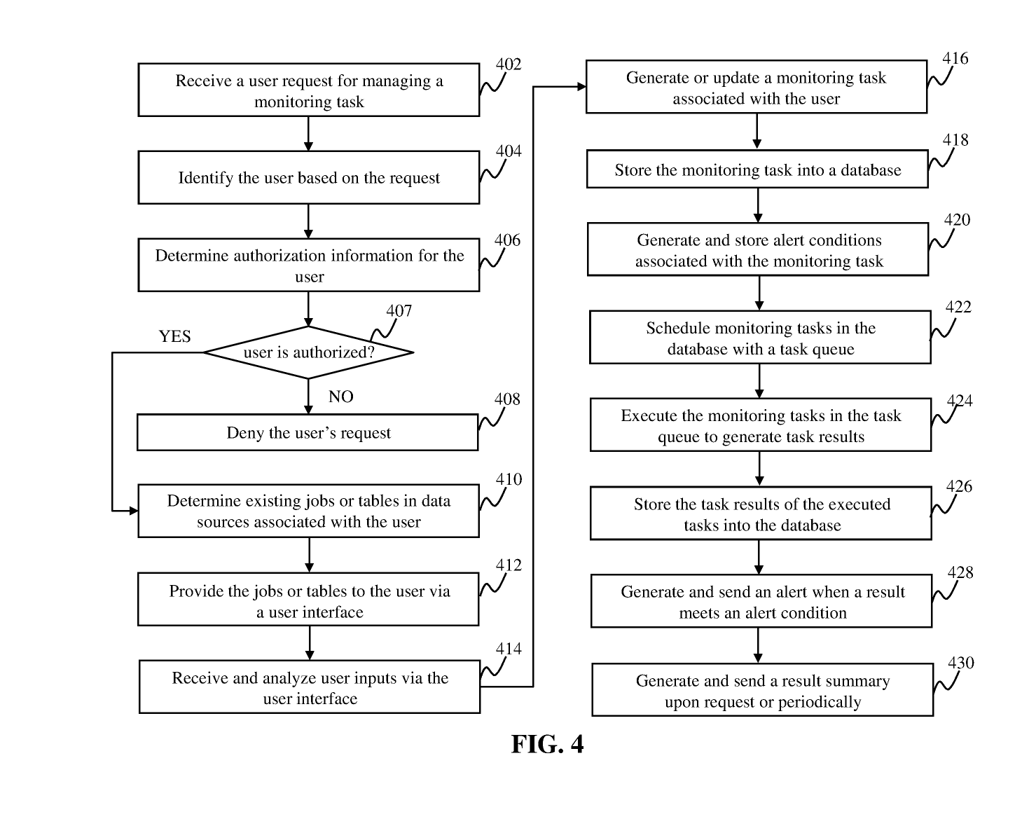

FIG. 4 is a flowchart of an exemplary process performed by a data source monitoring engine, e.g. the data source monitoring engine 104 in FIG. 3, according to an embodiment of the present teaching. At 402, a user request is received for managing a monitoring task. At 404, the user is identified based on the request. The user may be either an individual user 108 or a corporate user 102. At 406, authorization information is determined for the user. The authorization information may be stored in the data source monitoring engine 104 for the user, including information about the user and data authorized to be monitored by the user.

Based on the authorization information, at 407, it is determined whether the user is authorized for monitoring the data associated with the user request. If so, the process goes to 410, where existing jobs or tables in data sources associated with the user are determined, e.g. based on the user request. Otherwise, the process goes to 408, where the user request is denied, e.g. by providing a denial message to the user.

At 412, the jobs or tables are provided to the user via a user interface, such that the user can provide inputs to select or modify metrics for monitoring data. At 414, user inputs are received via the user interface and analyzed to determine metrics selected by the user. At 416, a monitoring task associated with the user is generated or updated, e.g. based on the metrics selected or modified by the user. At 418, the monitoring task is stored into a database. At 420, alert conditions are generated and stored in the database associated with the monitoring task.

At 422, various monitoring tasks in the database are scheduled with a task queue. The task queue may include e.g. monitoring tasks to be executed in the next hour, in a sequence according their respective running schedules. At 424, the monitoring tasks in the task queue are executed, e.g. one by one according to their respective running schedules, to generate task results. At 426, task results of the executed tasks are stored into the database, each associated with a corresponding monitoring task. At 428, an alert is generated when a result of a monitoring task meets an alert condition, and is sent to the user associated with the monitoring task. At 430, a result summary is generated and sent to a user, either periodically or upon request from the user.

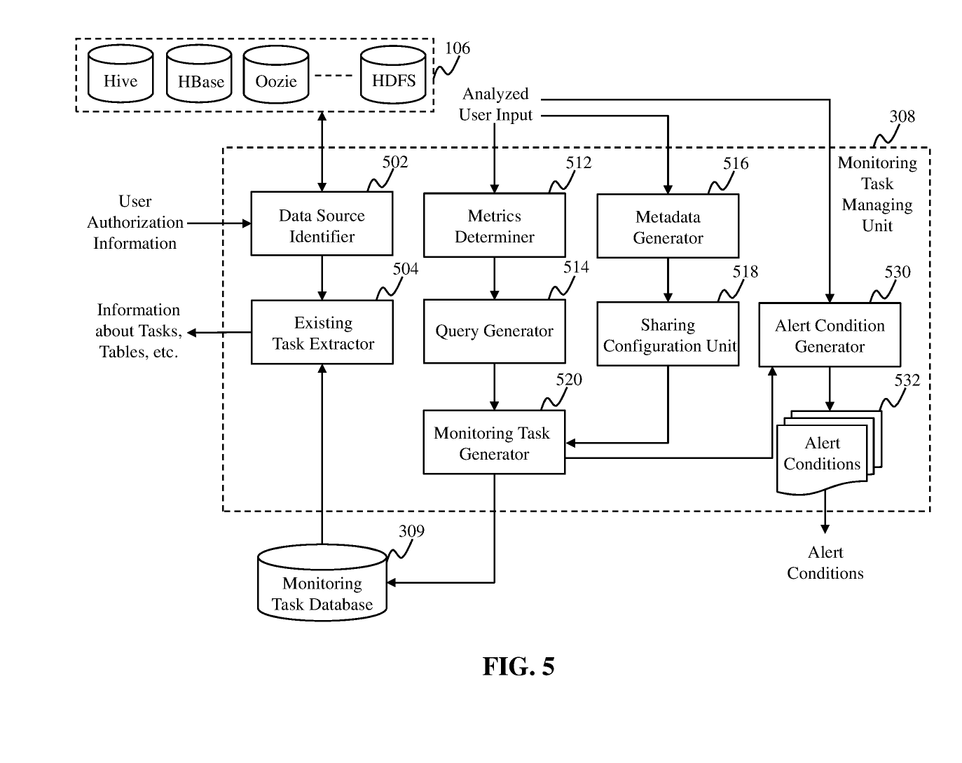

FIG. 5 illustrates an exemplary diagram of a monitoring task managing unit 308, according to an embodiment of the present teaching. The monitoring task managing unit 308 in this example includes a data source identifier 502, an existing task extractor 504, a metrics determiner 512, a query generator 514, a metadata generator 516, a sharing configuration unit 518, a monitoring task generator 520, an alert condition generator 530, and alert conditions 532.

The data source identifier 502 in this example receives user authorization information associated with a user and a request, e.g. from the user authorization unit 306. If the user authorization information indicates that the user is authorized to monitor data associated with the request, the data source identifier 502 may determine data sources associated with the user based on the request. For example, the data source identifier 502 may determine that the user is authorized to monitor data from Hive database. In one embodiment, the user requests to monitor some data but can be authorized to monitor only a subset of the data requested. This may be because the user's authority level is low such that he/she is not authorized to monitor some types of databases or some types of tables in a database.

The data source identifier 502 may retrieve information about the data to be monitored by the user, e.g. information about the tables in the identified data sources. The data source identifier 502 can then send the information about the data and the identified data sources to the existing task extractor 504 for task extraction.

The existing task extractor 504 in this example extracts, from the monitoring task database 309, existing monitoring tasks associated with the identified data sources and/or associated with the user. In one embodiment, the existing task extractor 504 may also extract monitoring tasks associated with other users and shared with the user, from the monitoring task database 309. The existing task extractor 504 may then provide, to the user, information about tables in the data sources, existing and/or shared tasks, etc.

The metrics determiner 512 in this example receives analyzed user input. The user input may be provided by a user via a user interface, to indicate the user's selection and/or modification related to a monitoring task. The metrics determiner 512 may determine metrics for monitoring data based on the analyzed user input. For example, the metrics may include one or more of the metrics illustrated in FIG. 14 under the “Checks” section 1410. The metrics may be directed to one or more data sources. The metrics determiner 512 can then send the metrics to the query generator 514 for query generation.

The query generator 514 in this example receives the metrics from the metrics determiner 512, and generates queries based on the metrics and the data sources associated with the metrics. For example, when there are two metrics each of which is associated with a different type of data source, the query generator 514 may generate two queries each of which is associated with one of the two metrics and based on a different query language.

The query generator 514 may also optimize the generated queries, e.g. based on the metrics. For example, when there are multiple queries generated for multiple metrics that have some common features and/or are related to a same data source, the query generator 514 may merge the multiple queries into one or two simple queries. The query generator 514 may then send the queries to the monitoring task generator 520 for monitoring task generation.

As such, the system can convert the user request into one or more queries that are automatically generated and optimized by the system. The user does not need to know any query language or input any query.

The metadata generator 516 in this example receives the analyzed user input, and generates metadata related to the metrics, e.g. based on the analyzed user input. The metadata may include e.g. information under the “Basic Info” section 1404 in FIG. 14. The metadata may also include some metadata metrics that can be pre-determined by an administrator of the system. In one embodiment, the metadata may include information about sharing configuration, e.g. whether the user wants to share a monitoring task with other users. The metadata generator 516 can then send the metadata to the sharing configuration unit 518 for determining sharing configuration.

The sharing configuration unit 518 in this example receives metadata from the metadata generator 516, and determines sharing configuration based on the metadata. The sharing configuration may indicate whether the user wants to share a monitoring task with other users. The sharing configuration may also indicate a list of users with whom the user wants to share a monitoring task. In one embodiment, the sharing configuration unit 518 may determine sharing configuration based on the user's personal information or historical behavior. For example, a lower level corporate user may have to share all monitoring tasks with a higher level corporate user in a same company, due to a pre-determined rule. In another example, if a user has never shared any monitoring task with any other user, the sharing configuration unit 518 may give a default sharing configuration for the user to avoid sharing any new monitoring tasks. After determining the sharing configuration, the sharing configuration unit 518 may then send the sharing configuration to the monitoring task generator 520 for monitoring task generation.

The monitoring task generator 520 in this example receives queries from the query generator 514 and sharing configuration from the sharing configuration unit 518. The monitoring task generator 520 can generate or update a monitoring task based on the queries and sharing configuration. The monitoring task generator 520 may then store the monitoring task associated with the user and the metadata, in the monitoring task database 309.

In one example, the monitoring task generator 520 can generate a new monitoring task associated with queries generated based on the user's input and associated with the pre-determined sharing configuration. The user's input may be received e.g. via the user interface 1400 in FIG. 14, where the user can either select some new metrics or modify pre-existing metrics. The monitoring task generator 520 may then store the monitoring task associated with the user. If the pre-determined sharing configuration indicates that the user wants to share the monitoring task with a list of other users, the monitoring task generator 520 may also store the newly generated monitoring task associated with the list of other users.

In another example, the monitoring task generator 520 can update an existing monitoring task associated with queries generated based on the user's input and associated with updated sharing configuration. Some of the user's input may be received e.g. via the user interface 1300 in FIG. 13, where the user can select either an existing monitoring task associated with the user or a monitoring task shared with the user. Some of the user's input may be received e.g. via the user interface 1400 in FIG. 14, where the user can modify pre-existing metrics associated with a selected monitoring task to update the selected monitoring task. The monitoring task generator 520 may then store the updated monitoring task associated with the user. If the user also updates the sharing configuration, e.g. by indicating a new list of other users to share the monitoring task, the monitoring task generator 520 may also store the updated monitoring task associated with the new list of other users.

In one embodiment, the monitoring task generator 520 may send information about the monitoring task to the alert condition generator 530 for generating alert conditions. The alert condition generator 530 in this example receives analyzed user input and information about the monitoring task. The alert condition generator 530 can generate alert conditions associated with the monitoring task based on the analyzed user input. The user input may be received e.g. via the user interface 1400 in FIG. 14, where the user may input either metrics for generating alerts either under “Alerts on Range Violation” 1416 or under “Alerts on Average Violation” 1418 in FIG. 14. The alert condition generator 530 may generate one or more alert conditions associated with the monitoring task. Each alert condition may be associated with a column as shown in FIG. 14.

The alert condition generator 530 may store the alert conditions 532 in the monitoring task managing unit 308 or store the alert conditions into the monitoring task database 309 (not shown). In either case, each alert condition is associated with a monitoring task, such that after the monitoring task is executed, the system can retrieve the associated alert condition and determine whether an alert should be generated based on the alert condition.

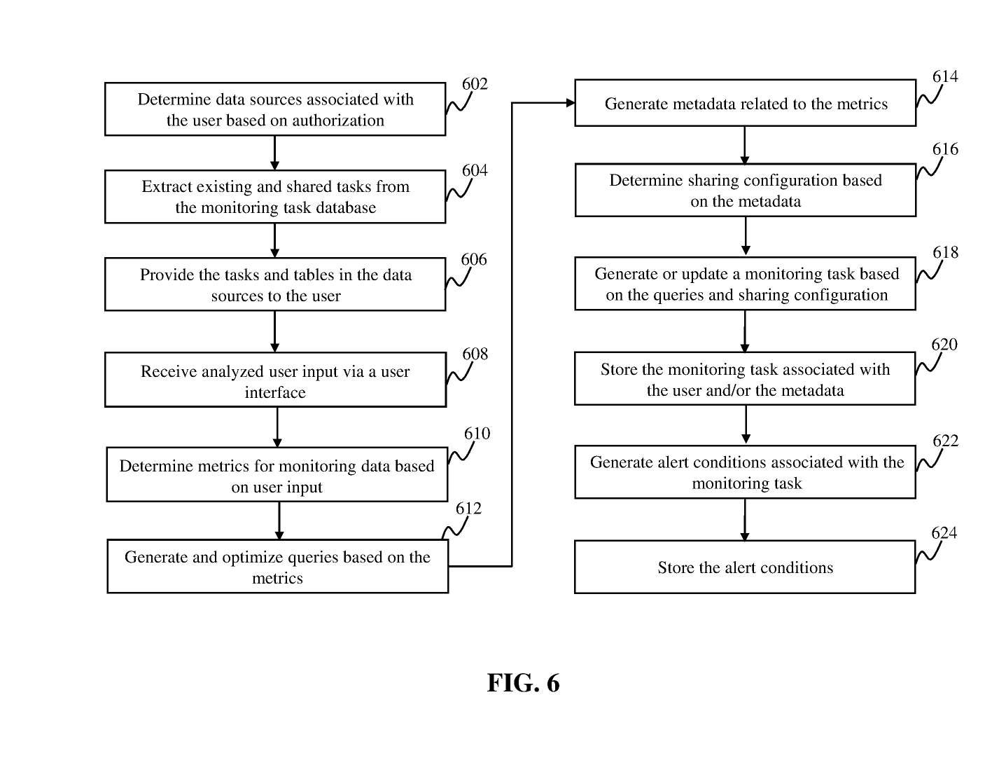

FIG. 6 is a flowchart of an exemplary process performed by a monitoring task managing unit, e.g. the monitoring task managing unit 308 in FIG. 5, according to an embodiment of the present teaching. At 602, data sources associated with the user are determined based on authorization, e.g. after determining that the user is authorized to monitor the data requested. At 604, existing and shared tasks associated with the user are extracted from the monitoring task database. At 606, information about the extracted tasks and tables in the determined data sources is provided to the user. At 608, analyzed user input is received via a user interface. At 610, metrics are determined for monitoring data based on the user input.

At 612, queries are automatically generated and optimized based on the metrics. At 614, metadata related to the metrics are generated. At 616, sharing configuration is determined based on the metadata. At 618, a monitoring task is generated or updated based on the queries and sharing configuration. At 620, the monitoring task is stored associated with the user, the metadata, and/or the sharing configuration. At 622, alert conditions associated with the monitoring task are generated. At 624, the alert conditions are stored associated with the monitoring task.

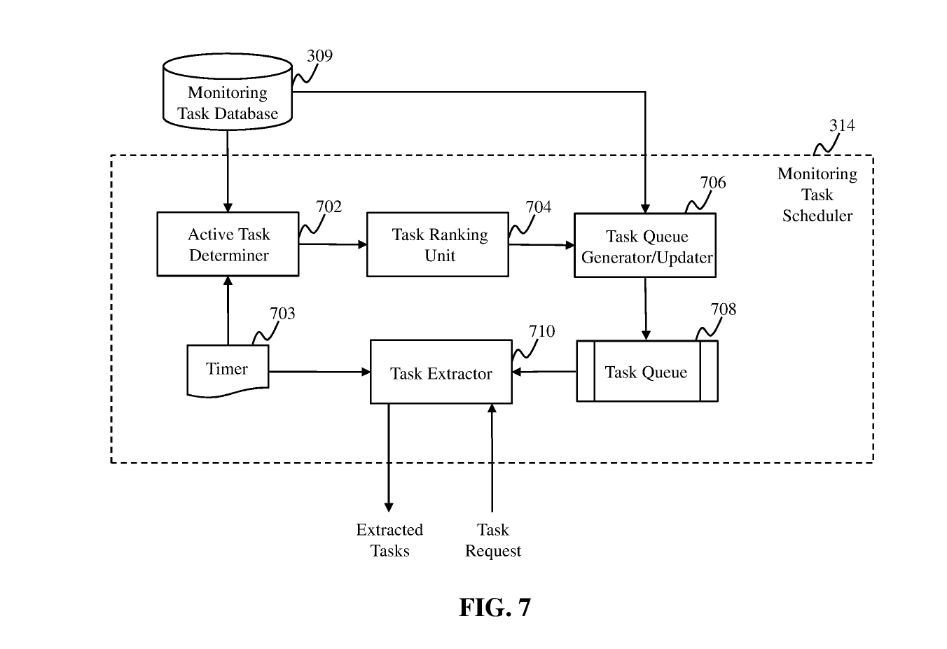

FIG. 7 illustrates an exemplary diagram of a monitoring task scheduler 314, according to an embodiment of the present teaching. The monitoring task scheduler 314 in this example includes an active task determiner 702, a timer 703, a task ranking unit 704, a task queue generator/updater 706, a task queue 708, and a task extractor 710.

The active task determiner 702 in this example can determine newly active monitoring tasks in the monitoring task database 309 in a given time period. Different monitoring tasks stored in the monitoring task database 309 may have different running schedules for execution, e.g. once every day at 12:00 PM, twice every day at 9:00 AM and 5:00 PM, once every hour, once every week, etc. The active task determiner 702 may determine that which monitoring tasks are scheduled to be executed in a time period, e.g. the next hour from current time, based on the time information provided by the timer 703. The determined monitoring tasks can be referred as active tasks in the monitoring task database 309 for the time period. In the above example, the active task determiner 702 may determine newly active task in the monitoring task database 309 once every hour.

After determining the newly active tasks, the active task determiner 702 may retrieve them from the monitoring task database 309. In one case, there is only one newly active task in a time period. In another case, there is no active task in a time period. The active task determiner 702 may then send the retrieved active task(s) to the task ranking unit 704 for task ranking.

The task ranking unit 704 in this example receives the retrieved task(s) from the active task determiner 702 and rank them, e.g. based on their respective scheduled execution times. For example, the active task determiner 702 may assign a higher ranking to a monitoring task that is scheduled to be executed in 5 minutes and assign a lower ranking to a monitoring task that is scheduled to be executed in 10 minutes. The task ranking unit 704 may send the ranked active monitoring tasks to the task queue generator/updater 706 for task queue generation.

The task queue generator/updater 706 in this example receives the ranked active tasks from the task ranking unit 704 and generates or updates the task queue 708, e.g. using the ranked active tasks. In one example, the system just initiates the data monitoring and the task queue generator/updater 706 may generate the task queue 708 and feed the task queue 708 with the ranked active tasks in order of their respective rankings, e.g. from higher ranked tasks to lower ranked tasks. The task queue 708 may follow a FIFO (first in first out) rule, such that a higher ranked task will be extracted from the task queue 708 and executed before a lower ranked task. In another example, after the system has executed monitoring tasks for some time, the task queue generator/updater 706 may update the task queue 708 and feed the task queue 708 with the newly ranked active tasks in order of their respective rankings, e.g. from higher ranked tasks to lower ranked tasks. In this case, the task queue 708 may also follow a FIFO rule, such that previous active tasks (if there are) in the task queue 708 will be extracted and executed before the newly ranked active tasks are extracted and executed.

In one embodiment, the active task determiner 702 may not retrieve the active monitoring tasks, but just retrieve some metadata about the active monitoring tasks from the monitoring task database 309. The task ranking unit 704 may rank the newly active tasks based on the metadata that may include information about the scheduled execution times for the newly active tasks, and generate a sequence of task IDs corresponding to the newly active tasks. The task queue generator/updater 706, after receiving the sequence of task IDs, can retrieve the newly active tasks from the monitoring task database 309 and update the task queue 708 accordingly.

The task extractor 710 in this example may extract monitoring tasks from the task queue 708, either according to the timer 703 or upon request, and send the extracted tasks for execution. In one embodiment, the task extractor 710 may receive a task request from the monitoring task executor 316, when the monitoring task executor 316 has an idle processer to execute a monitoring task. In response to the task request, the task extractor 710 may extract next queued monitoring task from the task queue 708 and send it to the monitoring task executor 316 for execution. In another embodiment, the task extractor 710 may extract next queued monitoring task from the task queue 708 according to the time information provided by the timer 703. For example, at one minute before the scheduled execution time of the next queued monitoring task, the task extractor 710 may extract the next queued monitoring task and send it to the monitoring task executor 316 for execution. In yet another embodiment, after the task extractor 710 receives a task request from the monitoring task executor 316, the task extractor 710 may wait until sometime (e.g. one minute) before the scheduled execution time of the next queued monitoring task, to extract the next queued monitoring task from the task queue 708 and send it to the monitoring task executor 316 for execution.

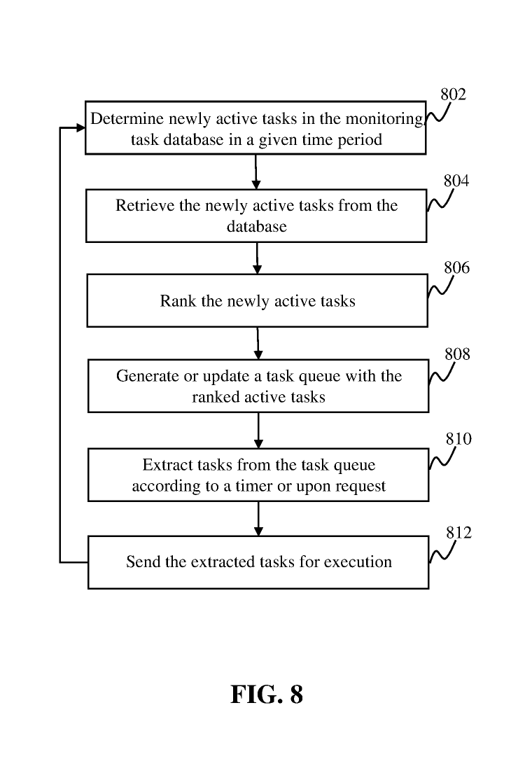

FIG. 8 is a flowchart of an exemplary process performed by a monitoring task scheduler, e.g. the monitoring task scheduler 314 in FIG. 7, according to an embodiment of the present teaching. At 802, newly active tasks in the monitoring task database are determined with respect to a given time period, e.g. an hour or a minute from the current time. At 804, the newly active tasks are retrieved from the database. At 806, the newly active tasks are ranked. As discussed before, the step of 804 may be performed after the step of 806. At 808, a task queue is generated or updated with the ranked active tasks. At 810, tasks are extracted from the task queue according to a timer or upon request. At 812, the extracted tasks are sent for execution. The process may then go back to 802 for determining newly active tasks for a next time period.

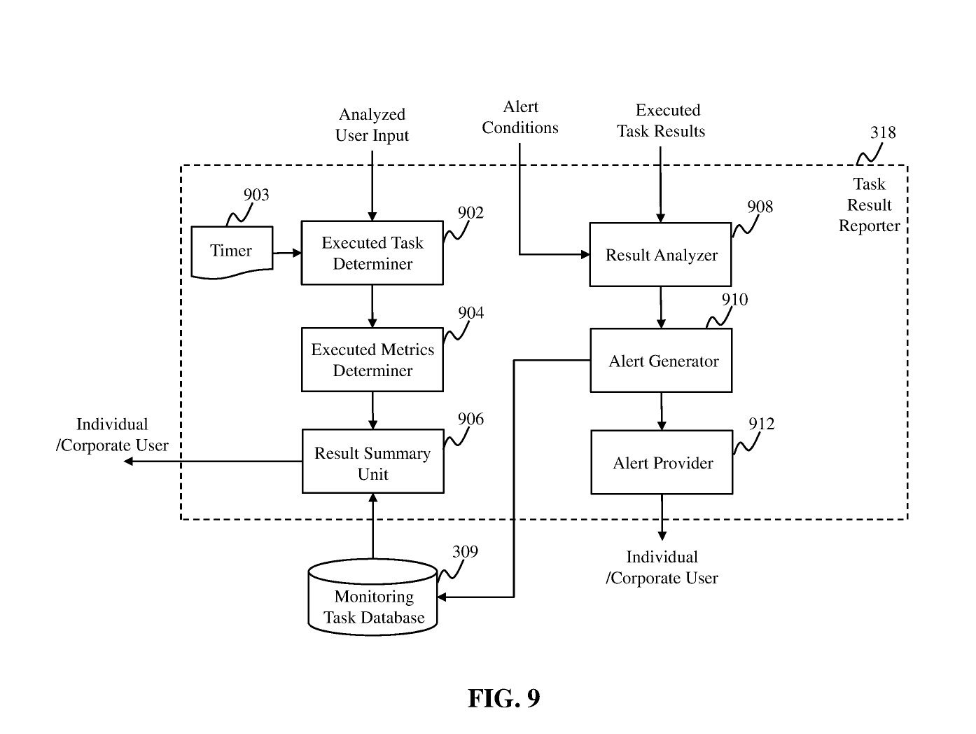

FIG. 9 illustrates an exemplary diagram of a task result reporter 318, according to an embodiment of the present teaching. The task result reporter 318 in this example includes an executed task determiner 902, a timer 903, an executed metrics determiner 904, a result summary unit 906, a result analyzer 908, an alert generator 910, and an alert provider 912.

The executed task determiner 902 in this example obtains a request for a monitoring result summary associated with a user. The request may be from the user and carried out by the analyzed user input. The request may also be from the timer 903, when a scheduled time comes for generating the result summary. For example, the system may periodically generate a result summary for a monitoring task and send to users associated with the task. The timer 903 may be synchronized with the timer 703.

Based on the request, the executed task determiner 902 may determine an executed task based on the request. The executed task determiner 902 can send information about the executed task to the executed metrics determiner 904. In one embodiment, the executed task determiner 902 may determine multiple executed tasks based on the request, and send information about each of the executed tasks to the executed metrics determiner 904. In that case, a result summary may be generated for each of the executed tasks.

The executed metrics determiner 904 in this example determines one or more metrics associated with the executed task received from the executed task determiner 902. In one embodiment, the executed metrics determiner 904 determines one or more metrics associated with each of the executed tasks received from the executed task determiner 902. The executed metrics determiner 904 can then send the determined metric(s) to the result summary unit 906 for generating the result summary.

The result summary unit 906 in this example can receive the determined metrics from the executed metrics determiner 904 and retrieve historical results corresponding to each of the metrics from the monitoring task database. For example, a monitoring task may be related to monitoring number of visitors on a web site every day. The result summary unit 906 may retrieve the visitor numbers in the past three months for the web site.

The result summary unit 906 may also retrieve previous alerts generated for the executed task. Referring to the above example about visitor numbers, an alert condition may be set for an alert to be triggered when any daily visitor number to be different from an average daily visitor number in the past three months by more than 50%. Then, the system might have generated one or more alerts each was triggered when the alert condition is met. The result summary unit 906 can retrieve information about each alert previously generated, including information about generation date and time, alert title, alert reason, etc.

The result summary unit 906 may generate a result summary based on the retrieved historical results and/or previously generated alerts associated with the executed task. The result summary unit 906 can provide the result summary to the user upon request from the user, or to user(s) subscribed to the executed task upon request from the timer 903 when the scheduled time for result summary comes. The result summary can be provided to the user via one or more user interfaces.

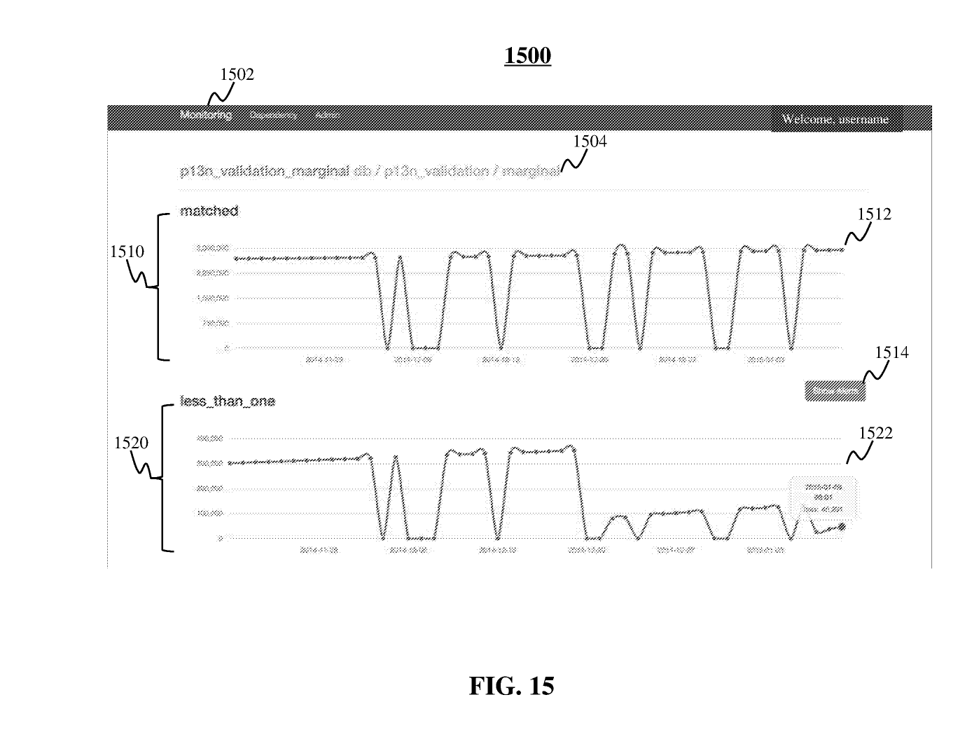

FIG. 15 illustrates a user interface displayed to a user to show results associated with a monitoring task, according to an embodiment of the present teaching. As illustrated in FIG. 15, the user interface 1500 in this example includes a menu bar 1502 which indicates that the user is under monitoring mode. The user interface 1500 also includes the name 1504 of the monitoring task. In one embodiment, the user interface 1500 may be provided to the user after the user clicks on a “Dashboard” button as illustrated in FIG. 13.

As illustrated in FIG. 15, the monitoring task in this example includes two metrics: “matched” 1510 and “less_than_one” 1520, and two curved lines 1512, 1522, each of which corresponding to one of the two metrics. Each curved line is generated by connecting dots that represent historical results of the metric. For example, in the curved line 1512, each dot represents a value of the metric “matched” based on the monitoring task executed in a past day. Thus, a curved line can provide a trend of a corresponding metric result in a past time period.

The user interface 1500 may also include a “Show Alerts” button 1514. In one embodiment, the user can access alerts generated for the monitoring task by clicking on the “Show Alerts” button 1514. In another embodiment, the user can access alerts generated for the metric “matched” 1510 by clicking on the “Show Alerts” button 1514 and another “Show Alerts” button (not shown) can be clicked to access alerts generated for the metric “less_than_one” 1520. In yet another embodiment, after the user clicks on the “Show Alerts” button 1514, a message “No Alert For this Dashboard” is displayed to the user when no alert has been generated for the metric “matched” 1510.

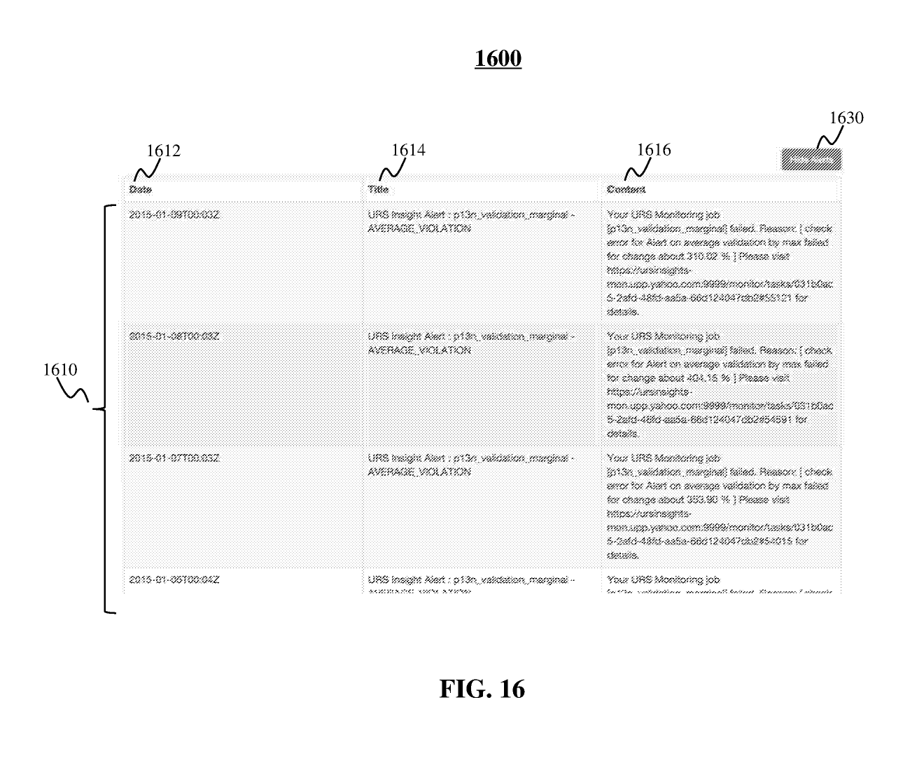

FIG. 16 illustrates a user interface displayed to a user to show alerts generated for a monitoring task, according to an embodiment of the present teaching. As illustrated in FIG. 16, the user interface 1600 in this example includes a plurality of records 1610 each of which represents an alert generated for the monitoring task. In one embodiment, each of the records 1610 represents an alert generated for a metric associated with the monitoring task. For example, the user interface 1600 may be provided to the user after the user clicks on a “Show Alerts” button for a metric, e.g. the metric “less_than_one” 1520 in FIG. 15.

As illustrated in FIG. 16, each of the records 1610 has three columns: “Date” 1612, “Title” 1614, and “Content” 1616. The “Date” 1612 for a record includes information about date and time when an alert was generated. The “Title” 1614 for the same record includes information about the title of the alert. For example, the “Title” 1614 may indicate that the type for an alert is Average Violation. As discussed above, this may mean that a metric value is different from a pre-determined average metric value by more than a pre-determined percentage. The “Content” 1616 for the same record includes information about the content of the alert. For example, the “Content” 1616 may include information about reasons for the generated the alert and/or a URL directed to details about the alert.

The user interface 1600 may also include a “Hide Alerts” button 1630. In one embodiment, the user can hide alerts generated for the monitoring task by clicking on the “Hide Alerts” button 1630. In another embodiment, the user can hide alerts generated for the metric associated with the alerts by clicking on the “Hide Alerts” button 1630 and other “Hide Alerts” buttons can be clicked to hide alerts generated for the other metrics associated with the monitoring task. In either embodiment, the “Hide Alerts” button 1630 will disappear and a “Show Alerts” button will be displayed.

In one embodiment, the system may have a default setting to display the alerts to the user when the result summary is first provided until the user clicks on the “Hide Alerts” buttons. In another embodiment, the system may have a default setting to hide the alerts from the user when the result summary is first provided until the user clicks on the “Show Alerts” buttons.

In one embodiment, the alert records 1610 may be displayed to the user in the user interface 1600 that is different from the user interface 1500 in FIG. 15. In another embodiment, the alert records 1610 may be displayed to the user besides a corresponding metric in the user interface 1500 in FIG. 15, after the user clicks on a “Show Alerts” button associated with the metric. For example, alert records corresponding to the metric “matched” 1510 can be displayed below the metric “matched” 1510 and above the metric “less_than_one” 1520 in the user interface 1500 in FIG. 15, after the user clicks on the “Show Alerts” button 1514. In that case, the “Show Alerts” button 1514 will disappear and a “Hide Alerts” button will be displayed along with the alert records.

Referring back to FIG. 9, the result summary unit 906 may provide to the user a result summary associated with the monitoring task via the user interface 1500 in FIG. 15 and/or the user interface 1600 in FIG. 16. It can be understood that the result summary can be provided to the user in other formats, e.g., an email, a video, a voice message, etc.

The task result reporter 318 in FIG. 9 can also generate an alert based on a just executed monitoring task and an alert condition. The result analyzer 908 in this example may receive results for an executed task associated with the user, e.g. from the monitoring task executor 316. The result analyzer 908 may also receive one or more alert conditions associated with the executed task. For example, the executed task may include three metrics, each of which is associated with an alert condition. The alert conditions may come from either the monitoring task managing unit 308 or the monitoring task database 309.

The result analyzer 908 can then analyze the results with the alert conditions. Based on the analysis, the result analyzer 908 can determine whether an alert condition is met and whether an alert needs to be generated accordingly. If one or more alert conditions are met, the result analyzer 908 may send information about the results and the alert conditions to the alert generator 910 for alert generation. If no alert condition is met, the result analyzer 908 may send information to the alert generator 910 for generating a no alert message.

The alert generator 910 in this example receives information from the result analyzer 908. If the information indicates that one or more alert conditions are met, the alert generator 910 can generate an alert for each of the met alert conditions associated with the task, e.g. in form a record or a message. Each alert may include information about data and time of the alert generation, type of alert condition violated, reasons for the alert generated, etc. The alert generator 910 can store the alert in association with the metric and/or the monitoring task into the monitoring task database 309. As such, the alert becomes one of the historical alerts displayed to a user associated with the metric when a user wants to see the historical alerts, e.g. by clicking on the “Show Alerts” button 1514 in FIG. 15. The alert generator 910 can also send the alert to the alert provider 912. The alert provider 912 in this example sends the generated alert to the user, e.g. by sending an email to an email address previously entered by the user.

If the information received from the result analyzer 908 indicates that no condition is met for a metric, the alert generator 910 can generate a no alert message associated with the metric and stores the no alert message into the monitoring task database 309 in association with the metric. As such, when a user clicks on a “Show Alerts” button for the metric, the system can provide the no alert message to the user. The no alert message may be e.g. “No Alert for this Metric.”

As discussed above, when the result summary unit 906 generates a result summary, the result summary may include information about alerts and/or no alert messages stored in association with a monitoring task.

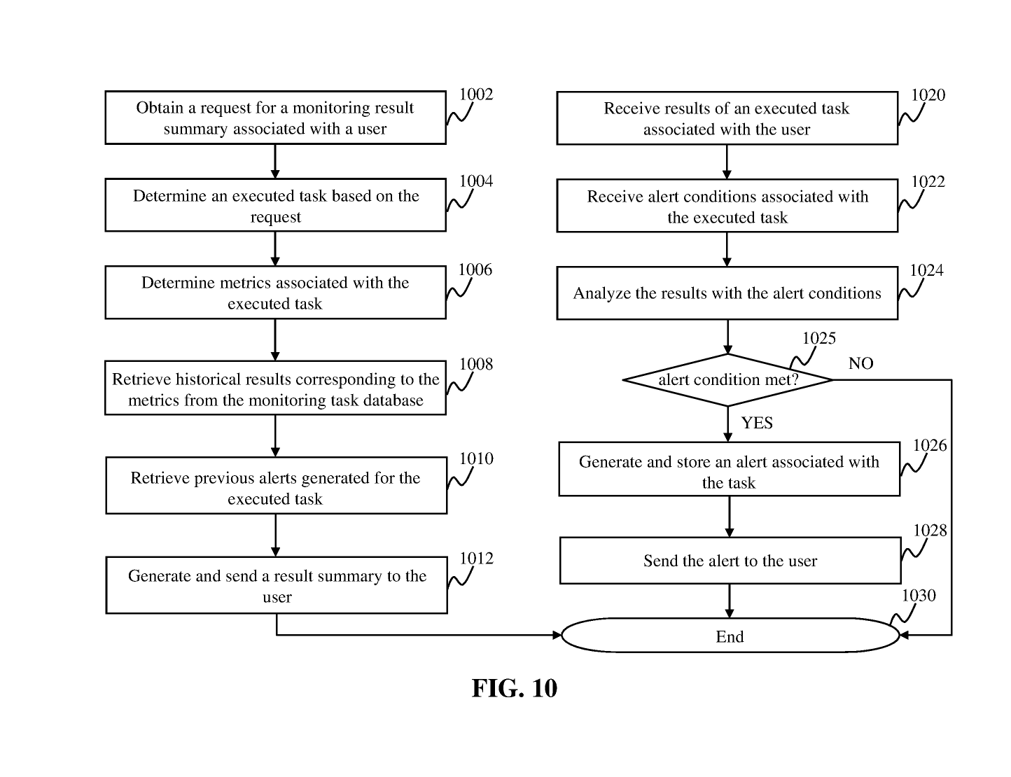

FIG. 10 is a flowchart of an exemplary process performed by a task result reporter, e.g. the task result reporter 318 in FIG. 9, according to an embodiment of the present teaching. At 1002, a request is obtained for a monitoring result summary associated with a user. The request may be received either from the user or from a timer when a scheduled time for summary generation comes. At 1004, an executed task is determined based on the request. At 1006, one or more metrics associated with the executed task are determined. At 1008, historical results corresponding to the metrics are retrieved from the monitoring task database. At 1010, previous alerts and/or no alert messages generated for the executed task are retrieved. In one embodiment, an alert or a no alert message is retrieved for each of the metrics associated with the executed task. At 1012, a result summary is generated and sent to the user. Then the process ends at 1030. In one embodiment, the process goes back from 1012 to 1002 to obtain another request for a monitoring result summary.

At 1020, results of an executed task associated with the user are received. At 1022, alert conditions associated with the executed task are received. At 1024, the results are analyzed with the alert conditions. At 1025, it is determined whether any alert condition is met, e.g. based on the analysis of the results with the alert conditions.

If an alert condition is met, the process goes to 1026, where an alert corresponding to the alert condition is generated and stored in association with the executed task and/or a metric of the executed task, e.g. in the monitoring task database 309. Then at 1028, the alert is sent to the user, e.g. via emails, phone calls, text messages, online chats, video calls, etc. The process then ends at 1030. In one embodiment, the process goes back from 1028 to 1020 to receive results of another executed task.

Otherwise, if no alert condition is met, the process goes to 1030 and ends. In one embodiment, the process goes back from 1025 to 1020 to receive results of another executed task, if no alert condition is met. In another embodiment, if no alert condition is met, a no alert message is generated and stored in association with the executed task and/or a metric of the executed task, e.g. in the monitoring task database 309.

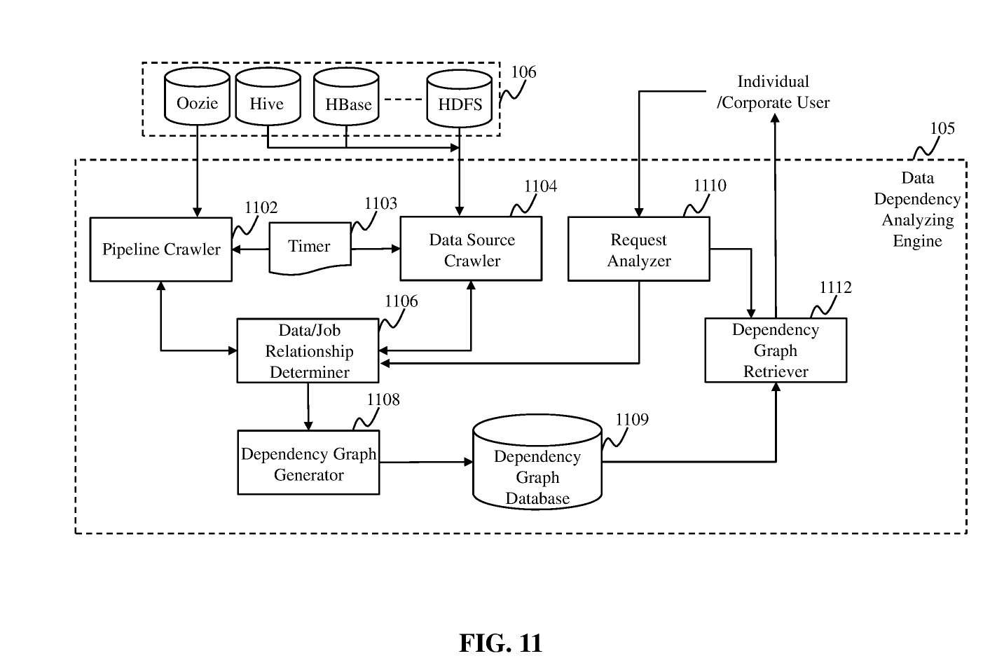

FIG. 11 illustrates an exemplary diagram of a data dependency analyzing engine 105, according to an embodiment of the present teaching. The data dependency analyzing engine 105 may collect information about different data sources in the data system 106 and information about different data processing jobs, e g running pipeline steps from a Oozie server in the data system 106. The data dependency analyzing engine 105 may determine dependency relationships among the data sources and running jobs to generate a data dependency graph, thus provide interrelationship among different pipelines running on a same cluster or different clusters in the data system 106. The data dependency analyzing engine 105 in this example includes a pipeline crawler 1102, a timer 1103, a data source crawler 1104, a data/job relationship determiner 1106, a dependency graph generator 1108, a dependency graph database 1109, a request analyzer 1110, and a dependency graph retriever 1112.

The pipeline crawler 1102 in this example is configured for collecting information of running pipelines. For example, on Hadoop, the pipeline crawler 1102 can obtain runtime information of pipelines from the Oozie server in the data system 106. The pipeline crawler 1102 may collect job information periodically based on time information from the timer 1103. The pipeline crawler 1102 may also collect job information upon a request, e.g. a request from the data/job relationship determiner 1106. In one embodiment, the timer 1103 may be synchronized with the timer 703 and/or the timer 903. The pipeline crawler 1102 may send the collected job information to the data/job relationship determiner 1106 for determining data/job relationships.

The data source crawler 1104 in this example is configured for collecting information of data sources, e.g. grid data sources like HDFS feeds, Hive tables, HBase tables in the data system 106. The data source crawler 1104 may collect data information periodically based on time information from the timer 1103. The data source crawler 1104 may also collect data information upon a request, e.g. a request from the data/job relationship determiner 1106.

The data dependency graph may include nodes representing data sources, nodes representing running jobs, and arrows each of which connecting two nodes and representing a dependency relationship between the two nodes. The data dependency graph may be generated either periodically or upon request. The data dependency analyzing engine 105 can provide the data dependency graph to a user for the user's better understanding of the data in the data system 106. The data source crawler 1104 may send the collected data information to the data/job relationship determiner 1106 for determining data/job relationships.

The data/job relationship determiner 1106 in this example receives job information from the pipeline crawler 1102 and receives data information from the data source crawler 1104. In one embodiment, the job information and the data information are associated with a same cluster that includes pipeline jobs and data sources. A pipeline job may consume data from a data feed and/or produce data into a data feed. In another embodiment, the job information and the data information are associated with multiple clusters.

The data/job relationship determiner 1106 can determine relationships among different pipeline steps and data sources. For example, a pipeline step may read data from a data source, process the data to generate some new data, and store the new data into another data source. In another example, a data source may provide data to a plurality of running pipeline steps at the same time. The data/job relationship determiner 1106 may send all of these determined relationships to the dependency graph generator 1108 for generating a dependency graph.

The dependency graph generator 1108 in this example receives the determined relationships among the jobs and data sources, and generates a dependency graph based on the determined relationships. The dependency graph can be a virtual representation that reflects and can be used to track overall status and healthiness of big data pipelines. For example, the dependency graph may include nodes that represent data feeds/sources and pipeline steps, and includes directed links among nodes to record how individual pipeline steps consume and/or produce data feeds. These graph elements like nodes and directed links may also be associated with job statistics information based on which advanced analytics and monitoring capabilities on pipelines can be implemented. Thus, the dependency graph can provide an overall picture of the producer-consumer relationship among different grid jobs and data sources.

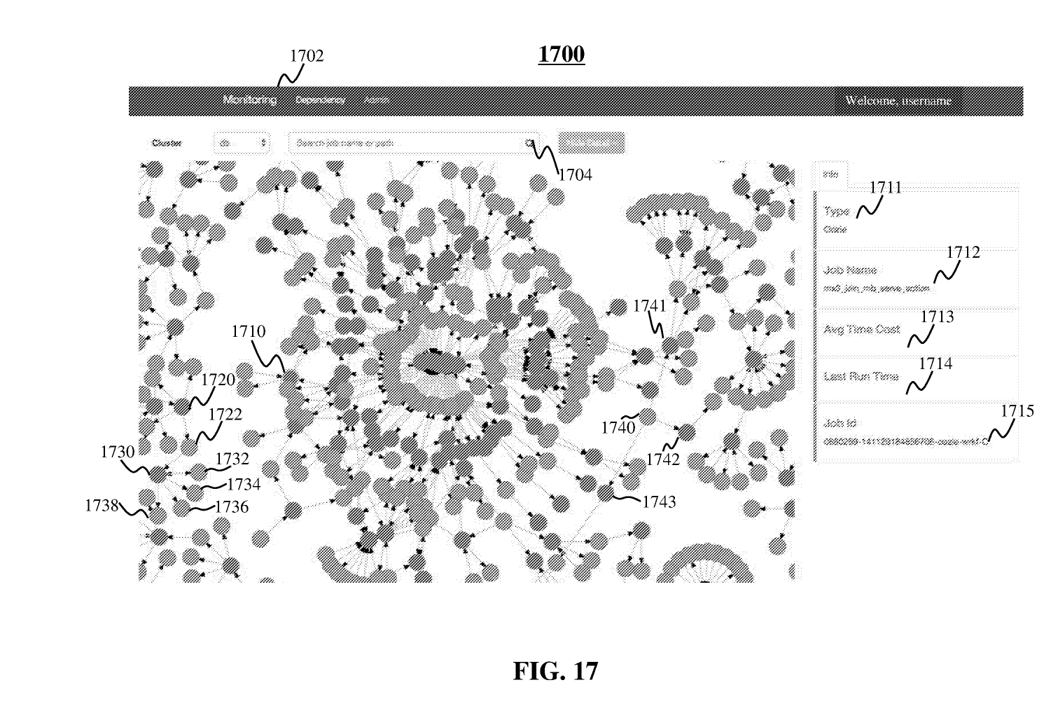

FIG. 17 illustrates a user interface displayed to a user to show a data dependency graph in a cluster, according to an embodiment of the present teaching. As illustrated in FIG. 17, a user interface 1700 includes a dependency graph that comprises a plurality of black nodes, a plurality of grey nodes, and a plurality of directed links. Each grey node in the user interface 1700 represents a data source in the cluster. The data source may be an HDFS feed, a Hive table, or an HBase table. Each black node in the user interface 1700 represents a pipeline step or a job that consumes or produces one of the data sources represented by a grey node. Each directed link represents a dependency relationship from one node to another. In one case, a link directed from a grey node representing a data source to a black node representing a job indicates that the job consumes or reads data from the data source. In another case, a link directed from a black node representing a job to a grey node representing a data source indicates that the job produces or outputs data into the data source.

The user can select any node in the user interface 1700 to view information about the node. The system can highlight the node selected by the user. For example, as illustrated in FIG. 17, a black node 1710 is selected and highlighted, such that information about the node 1710 is displayed on the right side of the dependency graph. Since the black node 1710 represents a job, the information about the node includes information about the job, e.g. “Type” 1711, “Job Name” 1712, “Avg Time Cost” 1713, “Last Run Time” 1714, and “Job Id” 1715. As shown in FIG. 17, the job type of the node 1710 is Oozie. It can be understood by one skilled in the art that some of the other black nodes in the user interface 1700 may have job types other than Oozie.

Advanced analytics can be performed based on the dependency information provided in the dependency graph in the user interface 1700. In one example, a job 1720 writes data into data source 1722, a job 1730 reads data from the data source 1722 and writes data into data sources 1732, 1734, 1736, 1738. Based on this dependency information, the user can determine that if there is any error in the job 1720, data in the data source 1722 may be impacted. Hence, the job 1730 and the data sources 1732, 1734, 1736, 1738 may also be impacted. As such, the user can predict error propagation in the data processing based on the dependency graph. On the other hand, if the user finds out there is an error in the data source 1736, the user may track down back the dependency chain to check whether there is any error happened in the job 1730, in the data source 1722, or in the job 1720. As such, the user can find the root of error during data processing, based on the dependency graph.

In one embodiment, a job may read data from a data source and write data into the same data source. For example, the job 1730 consumes and produces the data source 1732. In another embodiment, a data source may be consumed by multiple jobs at the same time. For example, the data source 1740 is consumed by the jobs 1741, 1742, 1743 at the same time or in a same time period.

The user interface 1700 includes a menu bar 1702 which indicates that the user is under monitoring and dependency mode. The user interface 1700 also includes a search box 1704 for the user to search job name or path in a cluster.

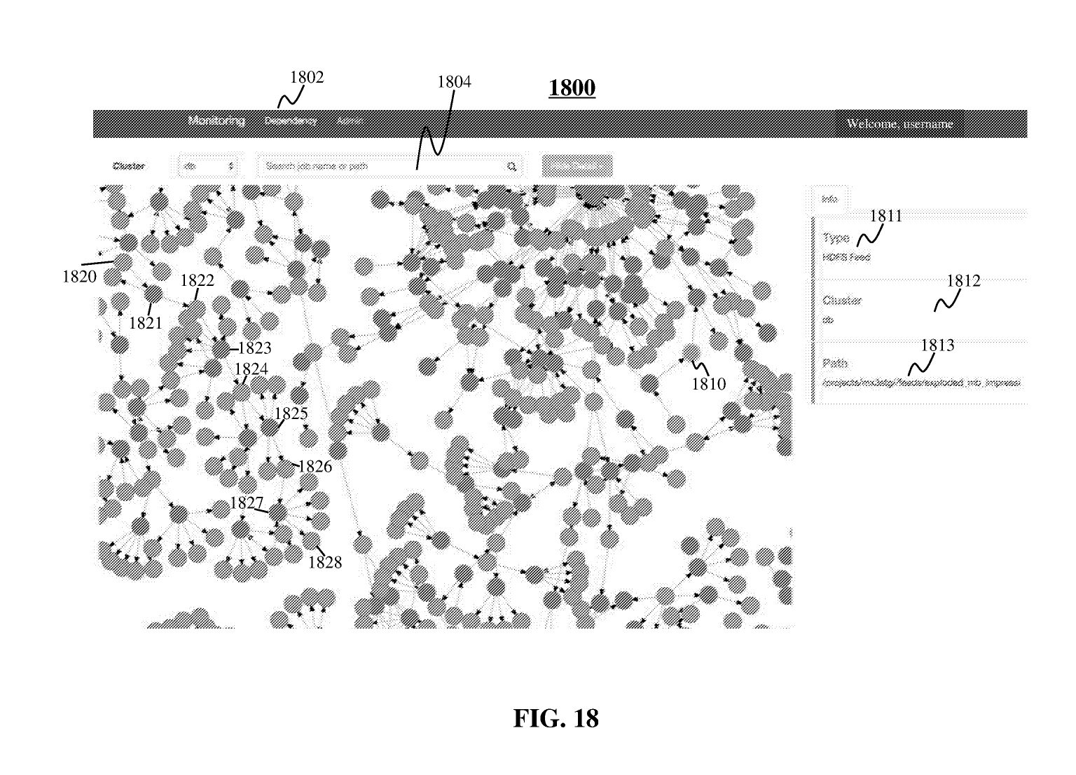

FIG. 18 illustrates another user interface 1800 displayed to a user to show a data dependency graph in a cluster, according to an embodiment of the present teaching. The user interface 1800 includes a menu bar 1802 which indicates that the user is under monitoring and dependency mode. The user interface 1800 also includes a search box 1804 for the user to search job name or path in a cluster.

Similar to the user interface 1700, the user interface 1800 includes a dependency graph that comprises a plurality of black nodes, a plurality of grey nodes, and a plurality of directed links. Each grey node in the user interface 1800 represents a data source in the cluster. Each black node in the user interface 1800 represents a pipeline step or a job that consumes or produces one of the data sources represented by a grey node. Each directed link in the user interface 1800 represents a dependency relationship from one node to another.

Similar to the user interface 1700, the user can select any node in the user interface 1800 to view information about the node. The system can highlight the node selected by the user. For example, as illustrated in FIG. 18, a grey node 1810 is selected and highlighted, such that information about the node 1810 is displayed on the right side of the dependency graph. Since the grey node 1810 represents a data source, the information about the node includes information about the data source, e.g. “Type” 1811, “Cluster” 1812, and “Path” 1813. As shown in FIG. 18, the type of the data source represented by node 1810 is HDFS Feed. It can be understood by one skilled in the art that some of the other grey nodes in the user interface 1800 may have data source types other than HDFS Feed.

The dependency graph in the user interface 1800 visualizes the dependency relationship among pipelines and data sources, such that a user can easily understand a dependency in the cluster without writing any queries. As illustrated in FIG. 18, the dependency graph includes a long dependency chain from node 1820 to node 1828, via nodes 1821, 1822, 1823, 1824, 1825. 1826. 1827. It would be difficult for a user to figure out this long dependency chain based on the user's own queries. With the dependency graph automatically provided by the system, the user can have a clear view of the long dependency chain. Based on the dependency relationships provided by the dependency graph, the system can also provide functions including but not limited to: global view of running pipelines; scope of impacts of changes to data feeds and pipelines; scope of impacts of the failures of certain pipelines; and pipeline specific analytics such as average runtime, resource consumption, failure or success rate, etc.

Referring back to FIG. 11, the dependency graph generator 1108 may generate a dependency graph and store it into the dependency graph database 1109 in association with a cluster. For example, the dependency graph generator 1108 may store the dependency graph in FIG. 17 or FIG. 18 into the dependency graph database 1109 in association with the cluster “db” as shown in FIG. 17 or FIG. 18. In other embodiment, a dependency graph may be generated for dependency relationships in a subset of a cluster, in a plurality of clusters, or even in a big data system including heterogeneous types of databases.

The request analyzer 1110 in FIG. 11 can receive and analyze a request for a dependency graph from a user. The request may be directed to a cluster, which means the user is interested in dependency relationships in the cluster. The request analyzer 1110 may determine information about the dependency graph and send it to the dependency graph retriever 1112 for dependency graph retrieval.

The dependency graph retriever 1112 in this example retrieves the dependency graph from the dependency graph database 1109 based on the information received from the request analyzer 1110. The dependency graph retriever 1112 may then provide the dependency graph to the user.

In one embodiment, there are multiple dependency graphs generated, at different times in the past, for the cluster requested by the user, and the user does not specify which one of the dependency graphs is requested. In this case, by default, the dependency graph retriever 1112 can retrieve the last generated dependency graph associated with the cluster.

In another embodiment, the request indicates that the user wants a real time dependency graph associated with the cluster. In this case, the request analyzer 1110 may send a message to the data/job relationship determiner 1106, such that the data/job relationship determiner 1106 can request job information and data information associated with the cluster from the pipeline crawler 1102 and the data source crawler 1104 respectively. The data/job relationship determiner 1106 can then determine dependency relationships among different jobs and data sources in the cluster in real time. Based on the determined dependency relationships, the dependency graph generator 1108 can generate the real time dependency graph. The real time dependency graph may be stored into the dependency graph database 1109 and/or retrieved by the dependency graph retriever 1112 and provided to the user.

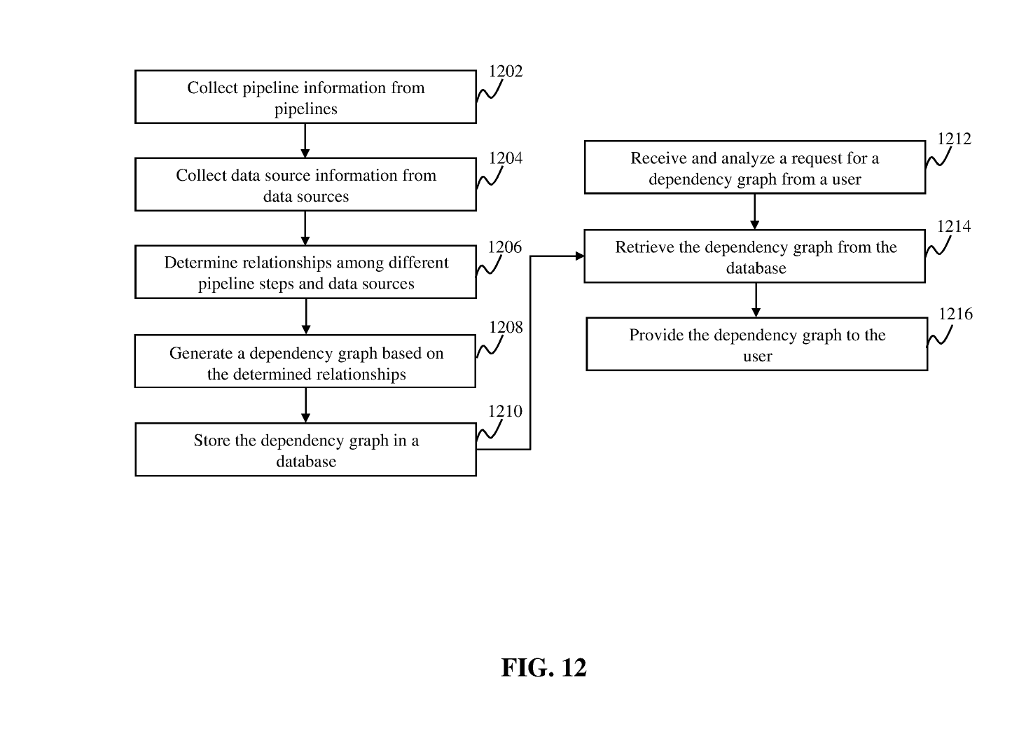

FIG. 12 is a flowchart of an exemplary process performed by a data dependency analyzing engine, e.g. the data dependency analyzing engine 105 in FIG. 11, according to an embodiment of the present teaching. At 1202, pipeline information is collected from pipelines, e.g. from a Oozie server. At 1204, data source information is collected from data sources, e.g. from Hive, HBase, HDFS, etc. At 1206, relationships among different collected pipeline steps and data sources are determined. The relationships can be determined in association with a cluster or a plurality of clusters. At 1208, a dependency graph is generated based on the determined relationships. At 1210, the dependency graph is stored in a database. In one embodiment, the process then goes to 1214 for retrieving the dependency graph upon request.

At 1212, a request for a dependency graph is received and analyzed from a user. At 1214, the dependency graph is retrieved from the database, based on the request. At 1216, the dependency graph is provided to the user, e.g. via a user interface as shown in FIG. 17 or FIG. 18.

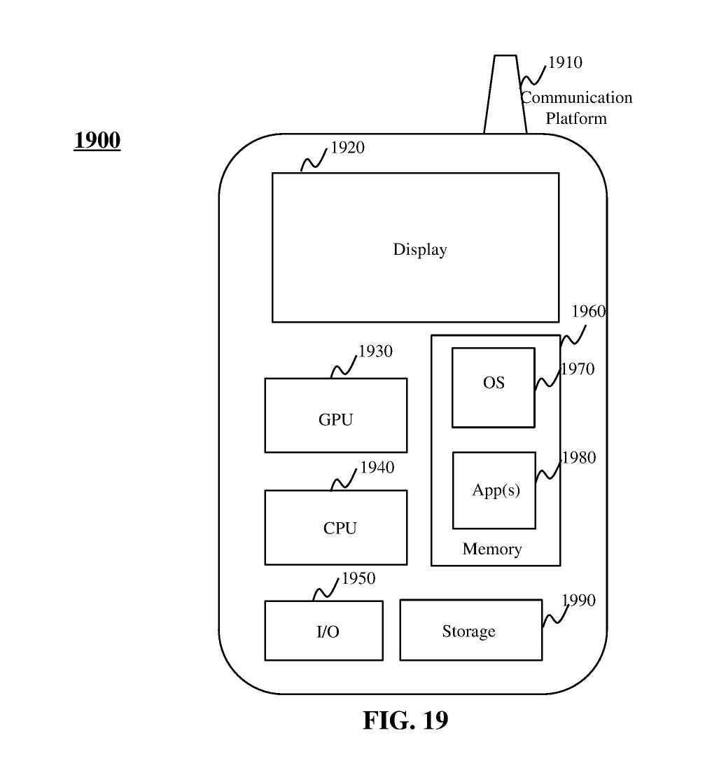

FIG. 19 depicts the architecture of a mobile device which can be used to realize a specialized system implementing the present teaching. In this example, the user device on which monitoring tasks are presented and interacted-with is a mobile device 1900, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1900 in this example includes one or more central processing units (CPUs) 1940, one or more graphic processing units (GPUs) 1930, a display 1920, a memory 1960, a communication platform 1910, such as a wireless communication module, storage 1990, and one or more input/output (I/O) devices 1950. Any other suitable component, including but not limited to a system bus or a controller (not shown), may also be included in the mobile device 1900. As shown in FIG. 19, a mobile operating system 1970, e.g., iOS, Android, Windows Phone, etc., and one or more applications 1980 may be loaded into the memory 1960 from the storage 1990 in order to be executed by the CPU 1940. The applications 1980 may include a browser or any other suitable mobile apps for data monitoring on the mobile device 1900. User interactions with the user interface 1300, 1400, 1500, 1600, 1700 or 1800 may be achieved via the I/O devices 1950 and provided to the data source monitoring engine 104 and/or the data dependency analyzing engine 105 via the network 110.

To implement various modules, units, and their functionalities described in the present disclosure, computer hardware platforms may be used as the hardware platform(s) for one or more of the elements described herein (e.g., the data source monitoring engine 104 and/or the data dependency analyzing engine 105 and/or other components of systems 100 and 200 described with respect to FIGS. 1-18). The hardware elements, operating systems and programming languages of such computers are conventional in nature, and it is presumed that those skilled in the art are adequately familiar therewith to adapt those technologies to generate and execute a monitoring task as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

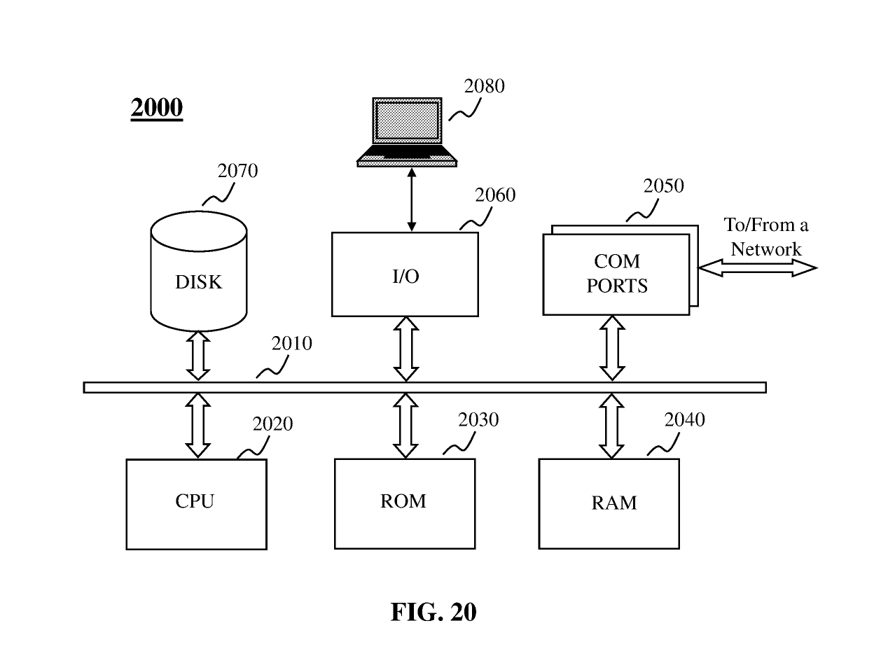

FIG. 20 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 2000 may be used to implement any component of the data monitoring techniques, as described herein. For example, the data source monitoring engine 104 and/or the data dependency analyzing engine 105 may be implemented on a computer such as computer 2000, via its hardware, software program, firmware, or a combination thereof. Although only one such computer is shown, for convenience, the computer functions relating to monitoring data in a plurality of data sources of heterogeneous types as described herein may be implemented in a distributed fashion on a number of similar platforms, to distribute the processing load.

The computer 2000, for example, includes COM ports 2050 connected to and from a network connected thereto to facilitate data communications. The computer 2000 also includes a central processing unit (CPU) 2020, in the form of one or more processors, for executing program instructions. The exemplary computer platform includes an internal communication bus 2010, program storage and data storage of different forms, e.g., disk 2070, read only memory (ROM) 2030, or random access memory (RAM) 2040, for various data files to be processed and/or communicated by the computer, as well as possibly program instructions to be executed by the CPU. The computer 2000 also includes an I/O component 2060, supporting input/output flows between the computer and other components therein such as user interface elements 2080. The computer 2000 may also receive programming and data via network communications.

Hence, aspects of the methods of data monitoring, as outlined above, may be embodied in programming Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a data source monitoring engine into the hardware platform(s) of a computing environment or other system implementing a computing environment or similar functionalities in connection with data monitoring. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the data monitoring as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform connected to a network for monitoring data in a plurality of data sources of heterogeneous types, the method comprising:
receiving a request for monitoring data in the data sources of heterogeneous types;
determining one or more metrics based on the request;
converting the request into one or more queries based on the one or more metrics, wherein each of the one or more queries is directed to at least one of the data sources of heterogeneous types; and
creating a monitoring task for monitoring the data in the data sources based on the one or more queries in response to the request.

2. The method of claim 1, further comprising:
storing the monitoring task associated with the user into a monitoring task database; and/or
executing the monitoring task according to a pre-determined schedule.

3. The method of claim 1, further comprising:
obtaining one or more inputs from the user with respect to the monitoring task;
generating one or more alert conditions associated with the monitoring task based on the one or more inputs; and
storing the one or more alert conditions, wherein an alert will be generated and sent to the user if one of the one or more alert conditions is met after the monitoring task is executed.

4. The method of claim 1, wherein the determining comprises:
determining one or more collections of data in the data source;
providing the one or more collections of data to the user;
receiving one or more inputs associated with at least one of the one or more collections of data from the user; and
determining one or more metrics based on the one or more inputs.

5. The method of claim 1, wherein the determining comprises:
determining one or more existing monitoring tasks associated with the user;
providing the one or more existing monitoring tasks to the user;
receiving one or more inputs from the user; and
determining one or more metrics based on the one or more inputs, wherein at least one of the one or more metrics is determined based on at least one of the one or more existing monitoring tasks.

6. The method of claim 1, wherein the determining comprises:
determining one or more other users associated with the user;
determining one or more shared monitoring tasks that are associated with the one or more other users and shared with the user by the one or more other users;
providing the one or more shared monitoring tasks to the user;
receiving one or more inputs from the user; and
determining one or more metrics based on the one or more inputs, wherein at least one of the one or more metrics is determined based on at least one of the one or more shared monitoring tasks.

7. The method of claim 1, wherein the creating further comprises customizing the one or more queries based on structure of the data source, and the structure includes at least one of: Hive, HBase, Oozie, and HDFS (Hadoop Distributed File System).

8. The method of claim 1, further comprising:
collecting first information related to the data sources;
collecting second information related to one or more jobs associated with the data sources;
determining one or more relationships among the data sources and the one or more jobs, based on the first and second information; and
generating a data dependency graph based on the one or more relationships.

9. The method of claim 8, wherein the data dependency graph comprises:
a first set of nodes each of which representing one of the data sources;
a second set of nodes each of which representing one of the one or more jobs; and
a set of directed links each of which connecting two nodes and representing a dependency relationship between the two nodes.

10. A system, having at least one processor, storage, and a communication platform connected to a network for monitoring data in a plurality of data sources of heterogeneous types, the system comprising:
a user request receiver configured for receiving a request for monitoring data in the data sources of heterogeneous types;
a metrics determiner configured for determining one or more metrics based on the request;
a query generator configured for converting the request into one or more queries based on the one or more metrics, wherein each of the one or more queries is directed to at least one of the data sources of heterogeneous types; and
a monitoring task generator configured for creating a monitoring task for monitoring the data in the data sources based on the one or more queries in response to the request.

11. The system of claim 10, further comprising:
a monitoring task managing unit configured for storing the monitoring task associated with the user into a monitoring task database; and/or
a monitoring task executor configured for executing the monitoring task according to a pre-determined schedule.

12. The system of claim 10, further comprising:
a user input analyzer configured for obtaining one or more inputs from the user with respect to the monitoring task; and
an alert condition generator configured for generating one or more alert conditions associated with the monitoring task based on the one or more inputs and storing the one or more alert conditions, wherein an alert will be generated and sent to the user if one of the one or more alert conditions is met after the monitoring task is executed.

13. The system of claim 10, further comprising:
a data source identifier configured for determining one or more collections of data in the data source;
a user interface generator configured for providing the one or more collections of data to the user; and
a user input analyzer configured for receiving one or more inputs associated with at least one of the one or more collections of data from the user, wherein the one or more metrics are determined based on the one or more inputs.

14. The system of claim 10, further comprising:
an existing task extractor configured for determining one or more existing monitoring tasks associated with the user;
a user interface generator configured for providing the one or more existing monitoring tasks to the user; and
a user input analyzer configured for receiving one or more inputs from the user, wherein the one or more metrics are determined based on the one or more inputs, and wherein at least one of the one or more metrics is determined based on at least one of the one or more existing monitoring tasks.

15. The system of claim 10, further comprising:
a data source crawler configured for collecting first information related to the data sources;
a pipeline crawler configured for collecting second information related to one or more jobs associated with the data sources;
a data/job relationship determiner configured for determining one or more relationships among the data sources and the one or more jobs, based on the first and second information; and
a dependency graph generator configured for generating a data dependency graph based on the one or more relationships.

16. The system of claim 15, wherein the data dependency graph comprises:
a first set of nodes each of which representing one of the data sources;
a second set of nodes each of which representing one of the one or more jobs; and
a set of directed links each of which connecting two nodes and representing a dependency relationship between the two nodes.

17. A machine-readable, non-transitory and tangible medium having information recorded thereon for monitoring data in a plurality of data sources of heterogeneous types, wherein the information, when read by the machine, causes the machine to perform the following:
receiving a request for monitoring data in the data sources of heterogeneous types;
determining one or more metrics based on the request;
converting the request into one or more queries based on the one or more metrics, wherein each of the one or more queries is directed to at least one of the data sources of heterogeneous types; and
creating a monitoring task for monitoring the data in the data sources based on the one or more queries in response to the request.

18. The medium of claim 17, when read by the machine, further causes the machine to perform the following:
obtaining one or more inputs from the user with respect to the monitoring task;
generating one or more alert conditions associated with the monitoring task based on the one or more inputs; and
storing the one or more alert conditions, wherein an alert will be generated and sent to the user if one of the one or more alert conditions is met after the monitoring task is executed.

19. The medium of claim 17, when read by the machine, further causes the machine to perform the following:
collecting first information related to the data sources;
collecting second information related to one or more jobs associated with the data sources;
determining one or more relationships among the data sources and the one or more jobs, based on the first and second information; and
generating a data dependency graph based on the one or more relationships.

20. The medium of claim 19, wherein the data dependency graph comprises:
a first set of nodes each of which representing one of the data sources;
a second set of nodes each of which representing one of the one or more jobs; and
a set of directed links each of which connecting two nodes and representing a dependency relationship between the two nodes.
